(19) United States
(12) Patent Application Publication
(10) Pub. No.: US 2026/0288547 A1
(43) Pub. Date: Sep. 24, 2026

(54) AUTOMATED PROGRESSION IN A PERFORMER AND EVALUATOR PIPELINE

(71) Applicant: Oracle International Corporation, Redwood Shores, CA (US)

(72) Inventor: Vivek Kumar, Austin, TX (US)

(73) Assignee: Oracle International Corporation, Redwood Shores, CA (US)

(21) Appl. No.: 19/088,703

(22) Filed: Mar. 24, 2025

(51) Int. Cl. G06F 9/54; G06F 40/40

(52) U.S. Cl. CPC G06F 9/543; G06F 40/40

(57) ABSTRACT

Example systems, methods, and computer-program products are described for using multiple AI agents to simulate performer-evaluator interaction and generate constructive feedback to automate pipeline progression. An example method includes a performer agent accessing performer-agent-accessible data potentially relevant to a project. The example method also includes the performer agent generating a performer recommendation to explain, from a performer perspective and with reference to at least some of the performer-agent-accessible data, why the project should advance in status according at least to stored objectives. The example method also includes an evaluator agent generating an evaluator recommendation to explain, from an evaluator perspective and with reference to at least some of the performer-agent-accessible data, why the project should not advance in status according at least to the stored objectives. The example method also includes causing display of at least part of the performer recommendation and at least part of the evaluator recommendation.

### BACKGROUND

Data management systems, such as process or project management systems, include software tools that can be used to manage data, streamline or optimize project workflows or other processes, automate or manage tasks, and/or manage user collaboration. For example, customer relationship management (CRM) software tools can be used to track customer interactions, automate tasks, and/or develop or implement targeted communication strategies.

Such tools may be accessible via a browser, app, or other client in connection with a cloud infrastructure that hosts software tool services. This architecture allows multiple users to separately update records, and these tools also include access constraints that prevent some users from making some updates while allowing other users to make those updates. In this manner, users may update records to provide details to other users towards an overall goal of project management.

### BRIEF SUMMARY

In some embodiments, a computer-implemented method includes a performer agent accessing performer-agent-accessible data potentially relevant to a project. The example computer-implemented method also includes the performer agent generating a performer recommendation to explain, from a performer perspective and with reference to at least some of performer-agent-accessible data, why the project should advance in status according at least to stored objectives. The example computer-implemented method also includes an evaluator agent generating an evaluator recommendation to explain, from an evaluator perspective and with reference to at least some of the performer-agent-accessible data, why the project should not advance in status according at least to the stored objectives. The example computer-implemented method also includes causing display of at least part of the performer recommendation and at least part of the evaluator recommendation.

In a particular embodiment, a computer-implemented method comprises accessing, by a performer agent, particular performer-agent-accessible data potentially relevant to a particular project. The computer-implemented method further comprises generating, by the performer agent, a particular performer recommendation to explain, with reference to at least some of the particular performer-agent-accessible data and from a performer perspective, why the particular project should advance in status according at least to stored objectives. Generating the particular performer recommendation may comprise generating a particular performer prompt to a large language model that includes a subset of the particular performer-agent-accessible data based at least in part on the particular project. The computer-implemented method further comprises accessing, by an evaluator agent, particular evaluator-agent-accessible data potentially relevant to the particular project and the particular performer recommendation. The computer-implemented method further comprises generating, by the evaluator agent, a particular evaluator recommendation to explain, with reference to at least some of the particular performer-agent-accessible data and from an evaluator perspective, why the particular project should not advance in status according at least to the stored objectives. Generating the particular evaluator recommendation may comprise generating a particular evaluator prompt to a large language model that includes a subset of the particular evaluator-agent-accessible data based at least in part on the particular project. The computer-implemented method further comprises causing display of at least part of the particular performer recommendation and at least part of the particular evaluator recommendation.

In a further embodiment, the particular evaluator prompt includes at least part of the particular performer recommendation.

In the same or a different further embodiment, the computer-implemented method further comprises configuring the performer agent to consume performer-agent-accessible data potentially relevant to a project and to generate a performer recommendation to explain, with reference to at least some of the performer-agent-accessible data and from the performer perspective, why the project should advance in status according at least to stored objectives. Configuring the performer agent to consume the performer-agent-accessible data may comprise storing one or more access parameters for the performer agent. Configuring the performer agent to generate the performer recommendation may comprise configuring the performer agent to generate a prompt to a large language model that includes a subset of the performer-agent-accessible data based at least in part on the project. The computer-implemented method further comprises configuring an evaluator agent to consume evaluator-agent-accessible data potentially relevant to the project and the performer recommendation and to generate an evaluator recommendation to explain, with reference to at least some of the performer-agent-accessible data and from the evaluator perspective, why the status of the project should not be advanced according at least to the stored objectives. Configuring the evaluator agent to consume the evaluator-agent-accessible data may comprise storing one or more access parameters for the evaluator agent. The one or more access parameters for the evaluator agent may be different than the one or more access parameters for the performer agent. Configuring the evaluator agent to generate the evaluator recommendation may comprise configuring the evaluator agent to generate a prompt to a large language model that includes a subset of the evaluator-agent-accessible data based at least in part on the project.

In another embodiment that extends the particular embodiment or any further embodiment, the performer agent accounts for a prior particular evaluator recommendation when generating the particular performer recommendation.

In another embodiment that extends the particular embodiment or any further embodiment, the evaluator agent accounts for a prior particular performer recommendation when generating the prior particular evaluator recommendation.

In another embodiment that extends the particular embodiment or any further embodiment, the computer-implemented method further comprises terminating a prior back-and-forth communication session between the performer agent and the evaluator agent based at least in part on determining by the evaluator agent that a prior status is satisfied.

In another embodiment that extends the particular embodiment or any further embodiment, the computer-implemented method further comprises terminating a prior back-and-forth communication session between the performer agent and the evaluator agent based at least in part on a number of particular evaluator recommendations in the prior back-and-forth communication session satisfying a threshold.

In another embodiment that extends the particular embodiment or any further embodiment, the particular evaluator-agent-accessible data comprises one or more sets of data that are not included in the particular performer-agent-accessible data.

In another embodiment that extends the particular embodiment or any further embodiment, the stored objectives include one or more objectives specific to the evaluator agent, and the one or more objectives are specified by an evaluator user via a user interface.

In another embodiment that extends the particular embodiment or any further embodiment, the stored objectives include one or more objectives specific to the performer agent, and the one or more objectives are specified by a performer user via a user interface.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that uses multiple AI agents to simulate performer-evaluator interaction and generate constructive feedback to automate project pipeline progression.

FIG. 2 illustrates a system diagram showing an example data management system that uses multiple AI agents to simulate performer-evaluator interaction and generate constructive feedback to automate project pipeline progression.

FIG. 3 illustrates a diagram of an example user interface showing interactions with multiple AI agents to automate objectives-based progression in an example sales pipeline management application.

FIG. 4A illustrates a system diagram showing an example sales pipeline management system that uses multiple AI agents to automate stage progression.

FIG. 4B illustrates example components of the sales agentic flow of FIG. 4A.

FIG. 5 illustrates a diagram of an example user interface of an example CRM application showing a list of projects assigned to a particular performer user.

FIG. 6 illustrates a diagram of another example user interface of the CRM application showing a particular project assigned to the particular performer user.

FIG. 7 illustrates a diagram of another example user interface of the CRM application showing activity details of a particular activity associated with the particular project.

FIG. 8 illustrates a diagram of another example user interface of the CRM application showing stage objectives associated with the particular project.

FIG. 9 illustrates a diagram of another example user interface of the CRM application showing a particular performer recommendation generated by an example performer agent and a particular evaluator recommendation generated by an example evaluator agent.

FIG. 10 illustrates a diagram of another example user interface of the CRM application showing an input form for receiving information about the particular project.

FIG. 11 illustrates a diagram of another example user interface of the CRM application showing example recommendations generated using one or more AI agents based on the information indicated in the input form.

FIG. 12 illustrates a diagram of another example user interface of the CRM application showing the particular project and including automatic updates generated using one or more AI agents.

FIG. 13 illustrates a diagram of another example user interface of the CRM application showing the stage objectives with automatic status updates determined using one or more AI agents.

FIG. 14 illustrates a diagram of another example user interface of the CRM application showing an updated performer recommendation generated automatically by the example performer agent and an updated evaluator recommendation generated automatically by the example evaluator agent.

FIG. 15 depicts a simplified diagram of a distributed system for implementing certain aspects.

FIG. 16 is a simplified block diagram of one or more components of a system environment by which services provided by one or more components of an embodiment system may be offered as cloud services, in accordance with certain aspects.

FIG. 17 illustrates an example computer system that may be used to implement certain aspects.

### DETAILED DESCRIPTION

Example systems, methods, and computer-program products are described for using multiple artificial intelligence (AI) agents to simulate performer-evaluator interaction and generate constructive feedback to automate project pipeline progression. In various embodiments, the use of multiple AI agents to simulate performer-evaluator interaction and generate constructive feedback to automate project pipeline progression is implemented using non-transitory and/or transitory computer-readable storage media to store instructions which, when executed by one or more processors of a computer system, cause display of the user interface and processing of the received input to generate constructive feedback and automate project pipeline progression by using multiple AI agents to simulate performer-evaluator interaction. The use of multiple AI agents to simulate performer-evaluator interaction and generate constructive feedback to automate project pipeline progression may be implemented on a local or cloud-based computer system that includes processors and a display for showing the user interface to a user for a system that uses multiple AI agents to simulate performer-evaluator interaction and generate constructive feedback to automate project pipeline progression. The computer system may communicate with client computer systems for using multiple AI agents to simulate performer-evaluator interaction and generate constructive feedback to automate project pipeline progression.

A description of using multiple AI agents to simulate performer-evaluator interaction and generate constructive feedback to automate project pipeline progression is provided in the following sections:
PROCESS MANAGEMENT, MULTI-STAGE PROJECT WORKFLOWS, AND OBJECTIVES BASED PROGRESSION FRAMEWORKS
PERFORMERS, EVALUATORS, AND POTENTIAL BOTTLENECKS IN A PROJECT OR PROCESS PIPELINE
MANAGING, TRACKING, AND ANALYZING DATA RELEVANT TO ACHIEVING OBJECTIVES
DATA ANALYSIS USING LLMS
AGENTIC AI INTEGRATION TO SUPPORT LLM DATA ANALYSIS OF OBJECTIVES AND USER ACTIVITY FROM DIFFERENT PERSPECTIVES
USING MULTIPLE AI AGENTS TO SIMULATE PERFORMER-EVALUATOR INTERACTION AND GENERATE CONSTRUCTIVE FEEDBACK
EXAMPLE APPLICATIONS FOR USING MULTIPLE AI AGENTS TO AUTOMATE AND IMPROVE WORKFLOWS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Process Management, Multi-Stage Project Workflows, and Objectives Based Progression Frameworks

Process management systems and/or other data management software tools can be used to implement a systematic approach for planning, executing, and/or overseeing workflows to ensure tasks are completed efficiently and effectively, e.g., by aligning the workflows with organizational goals and/or by improving overall performance of a collaborative project. Process management systems can enhance efficiency and effectiveness, for example, by identifying bottlenecks, streamlining workflows, and/or optimizing resource allocation. Process management systems can also be used to document processes and procedures thereby improving consistency and knowledge sharing across an organization.

In some examples, a process or project management system can be used to manage multi-stage project workflows and/or other complex processes. Each stage, for instance, may be associated with a set of objectives to be achieved before progressing to a next stage of the project workflow. In various applications, objectives may be user-defined, dynamically updated over time (e.g., by a project leader or other senior user), and/or described in a natural language format (e.g., “Identify key decision makers and verify their contact information.”).

By way of example, a CRM system can be used to manage complex business-to-business (B2B) processes, which may involve multiple communications and/or events over an extended period of time (e.g., 1 month, 6 months, 2 years, etc.) for instance, in a structured and consistent manner so that B2B opportunities (e.g., projects) are processed in a pipeline according to a sequence of well-defined project stages (e.g., from a customer engagement stage to an opportunity closing stage). For instance, each stage may be assigned a set of objectives (e.g., identify key contacts, collect contact information, etc.) which act as guidelines for a user (e.g., sales representative) to perform user actions (e.g., send emails, conduct research, etc.) for achieving the set of objectives of a current stage before progressing to a next stage in the pipeline. The CRM system may also store user activity data associated with each objective so that other users (e.g., sales manager) can monitor or validate progress of the opportunity or project over time, flag missing information, or flag potential delays in the pipeline.

As another example, an education management system can be used to manage a learning content delivery pipeline over multiple stages. For instance, a first stage may be associated with a first set of objectives (e.g., “Demonstrate ability to add or subtract fractions.”) which a user (e.g., student) should complete before advancing to a next stage of the pipeline associated with a second set of objectives (e.g., “Demonstrate ability to multiply or divide mixed numbers.”). In this example, objectives may act as guidelines for the user to perform certain user actions or tasks or engage certain software features (e.g., play lecture video, take practice test, etc.) to achieve the objectives of a current stage before progressing to a next stage in the pipeline.

### Performers, Evaluators, and Potential Bottlenecks in a Project or Process Pipeline

In some process management systems, certain functions or actions may be performed or reported, typically at least in part by a user, as support for completion of one or more objectives of a current stage of a pipeline and/or to justify progression from the current stage to a next stage of the pipeline. Such functions may be referred to herein as ‘performer’ functions, workflows, or sub-processes. For example, in a CRM system configured to manage sales processes, the functions or role of a ‘performer’ may be performed, at least in part, by a sales representative (e.g., first user) that documents certain actions (e.g., emails, notes, meeting transcripts, etc.) and/or provides other information to the CRM system as support or evidence of satisfying one or more objectives of the current stage and/or to justify progressing from the current stage to the next stage of the pipeline.

In some process management systems, other user roles, functions, etc., may be defined as well such as the role of a ‘reviewer’ or ‘evaluator’. For example, in some example CRM systems herein, functions of an ‘evaluator’ role may optionally be performed, at least in part, by a sales manager (e.g., second user) that reviews documented efforts of the first user (e.g., actions, emails, other information, etc.) against the objectives of the current stage to confirm or reject the first user's assertion that the objectives have been satisfied and/or to approve or reject progression to the next stage of the pipeline.

In some traditional systems however, due to significant resource and time overhead and/or other limitations associated with manual analysis and review of potentially large volumes of data, some of the functions of the performer and/or the evaluator roles described above may instead be performed by a single user, intermittently performed, or omitted from the pipeline. For example, in many traditional CRM systems, stage progression is typically a manual process where a sales representative user subjectively decides when to move to a next stage of the sales pipeline by reviewing his or her own activity to subjectively decide whether objectives of a current stage are satisfied without any comprehensive analysis or feedback from his or her sales manager. Furthermore, in many traditional systems, reviewing user activity data manually to subjectively decide whether stage objectives are satisfied may be prone to inconsistencies, variabilities, inaccuracies, and/or subjective bias. Thus, in some scenarios, excessive reliance on human input at various stages of a pipeline may result in performance and/or quality pipeline bottlenecks due to time constraints, resource constraints, user variability, subjective bias, and/or other human errors or variability factors.

Accordingly, the present disclosure includes example systems and methods that address and/or mitigate these issues by leveraging artificial intelligence (AI) techniques to, for example, automate stage progression in a pipeline, automatically analyze user activity and stage objectives from different perspectives (optionally in real-time or near-real-time), and/or automatically generate constructive feedback to improve quality, accuracy, consistency, and/or efficiency of pipeline management and stage progression processes.

### Managing, Tracking, and Analyzing Data Relevant to Achieving Objectives

Example systems and methods are described herein for managing, tracking, and/or analyzing data relevant to achieving objectives of a project or process pipeline. An example data management system may collect, organize, and analyze user inputs in real time or near real time. For instance, an example CRM system may dynamically update its analysis of whether any objective is completed or partially completed whenever new information (e.g., email, etc.) is input or captured by the CRM system.

In an example, the data management system includes a user interface that a user (e.g., performer) can use to submit data, report user actions, or provide any other input information that can support, at least in part, completion or partial completion of one or more objectives. For instance, an example CRM system may include a user interface that a sales representative can use to input or document activities (e.g., emails, telephone call transcripts, notes, etc.) or other information that supports or proves completion or partial completion of one or more objectives.

In an example, the data management system is configured to automatically track or capture user activity data that is relevant to one or more objectives or projects assigned to the user. For instance, the data management system may use one or more application programming interfaces (APIs) to monitor and parse emails in an email application, voice recordings or transcripts from a telephone or video conferencing application, and/or any other external source of data for information that is relevant to a project assigned to the user in the data management system. The data management system may also parse or extract certain types of information from the captured data into categories (e.g., contact information, activity types, etc.) by analyzing natural language content in the captured or tracked data.

In an example, the data management system may retrieve information relevant to a particular project from historical data associated with other similar projects or workflows. For instance, an example CRM system may access historical project data to identify contacts, etc., associated with a particular customer.

Thus, in some embodiments, the data management system may streamline data capture and/or collection from different sources or in different formats in real time or near real time and optionally update objective progress analysis soon after new information becomes available from any data source. Furthermore, in some embodiments, the data management system can leverage advanced AI techniques such as natural language processing (NLP) to glean data driven insights from various sources of relevant natural language content.

### Data Analysis Using LLMS

In line with the discussion above, an example data management system may configure a large language model (LLM) with information about objectives, stages, user activity, and so on. By leveraging LLM natural language processing (NLP) capabilities, the data management system can obtain a thoughtful analysis of objective progress in a natural language format based on the LLM understanding natural content descriptions of the objectives and natural language content descriptions of user actions or activities submitted or captured as supporting evidence for assessing completion or partial completion of one or more objectives.

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, Llama 3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data or any other data available in a user session with an application. The data schema may include dimension names (e.g., objectives, activities, activity types, stages, etc.), member names, and drill-down or roll-up hierarchies that are available to view or manipulate in the user session. The data schema may be formatted in a hierarchical format, such as JSON, XML, or another structured and delimited format that distinguishes between members at different levels of the hierarchy.

The prompts may also specify a format for providing the reply, through example valid responses to example requests, and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any. If the LLM reply includes a data structure consumable by the application, the validation may include verifying that the data structure conforms to a schema or set of structured instructions exposed by the application through an API.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The values may be embedded in the delimiters and extracted from the embedded structure to determine values predicted by the LLM. The consumable JSON object may be separated from a remainder of the response for consumption by the application to create an executable structure to trigger application functionality.

### Agentic AI Integration to Support LLM Data Analysis of Objectives and User Activity From Different Perspectives

An AI agent generally includes a system or system component configured to autonomously perform one or more tasks on behalf of a user or other system component by implementing a customizable workflow and/or using one or more agent tools. To that end, an AI agent can be configured to combine various functionalities such as natural language processing, decision making, problem solving, interacting with external environments, executing actions, and so on. In some configurations, an AI agent can be deployed within an application to assist with complex tasks. For instance, an AI agent can be configured to use NLP techniques of LLMs to comprehend and/or respond to user inputs and determine how to control or use one or more agent tools.

Agent tools may include software components or other external systems that are accessible to an AI agent to perform certain functions or tasks. For example, an agent tool may correspond to a software service (e.g., email application, data server, web browser application, etc.) that is accessible to the AI agent via an API or other interface. An AI agent may decide (e.g., autonomously without human intervention or with a human-in-the-loop for approval or adjustment, etc.) how or when to use the various available agent tools to perform the tasks that the AI agent is configured to automate. Thus, an example AI agent herein can be configured to use LLMs, other machine learning models, agent tools, and/or APIs to interact with users, other system components, other systems, and/or to execute certain functionalities or tasks. Thus, some AI agents can be configured to handle complex workflows and/or multi-step tasks by leveraging available tools and/or APIs. Furthermore, AI agents may be designed to adapt to dynamic environments and/or changing conditions, e.g., by using tools and/or APIs to access real-time information.

In some examples, an AI agent can use an API authentication mechanism to ensure secure access to APIs or other data server interfaces accessible via an agent tool by verifying the identity of clients making requests. For example, API keys may include credentials issued to identify applications (e.g., the data management system, etc.) accessing an API, and may be included in request headers, URL parameters, etc., without necessarily having a built-in expiration or user-based access control. In another example, bearer tokens (e.g., OAuth 2.0, etc.) may include temporary access tokens (e.g., granted after a more comprehensive authentication such as OAuth 2.0), allowing secure, time-limited access to resources (e.g., agent tools) without necessarily exposing credentials. Other methods for accessing agent tools may include ‘Basic Authentication’, which is a process that involves sending a username and password encoded in a request (e.g., HTTP request, HTTPS request, etc.). Another example authentication mechanism includes JSON Web Tokens (JWT), which encode user information for token-based authentication. Another example authentication mechanism includes Mutual TLS (mTLS) which could add an extra layer of security by requiring client and server devices to authenticate each other using certificates. Another example authentication mechanism includes Hash-based Message authentication code (HMAC), where message integrity may be ensured by signing requests with a secret key. Other authentication mechanisms are possible as well depending on security requirements or preferences, user-specific access requirements or preferences, and/or sensitivity of data retrieved using the agent tools, among other factors.

In various embodiments, different agents may have access to different authentication mechanisms and/or different authentication keys, shared secrets, or other authentication parameters, which may provide different levels of access to the different agents. For example, a performer agent may have access to a first set of tool(s) that use a first set of data to support requests for the performer agent, and an evaluator agent may have access to a second set of tool(s) that use a second set of data to support requests for the evaluator agent. The same or different level(s) of access to same or different tool(s) may be driven by same or different authentication parameter(s) used by the different agents, and the authentication parameter(s) may be communicated to same or different API(s) that support tool functionality, which may have access to same or different set(s) of data in a back-end database, such as access that is driven by role(s) or security profile(s) associated with the authentication parameters provided to authenticate for API use and/or separate role(s) or security profile(s) managed by the tool that provides data lookup, analysis, management, data generation or other content generation, or other functionality to the agent(s).

In some aspects, an example system herein integrates one or more AI agents to automate, streamline, support, and/or enhance certain processes in a project pipeline. For instance, the system may include an agent configured to perform or assist with the functions of a performer or an evaluator or any other role associated with the project pipeline. By way of example, an example CRM system may include an agent configured to analyze user activity data (e.g., emails, meeting transcripts, notes, etc.) submitted by a sales representative user (e.g., performer), and to generate an analysis summary in a natural language format that explains or justifies whether the user activity satisfies one or more project objectives. To facilitate this, for example, the agent may automatically use any combination of available LLMs, machine learning models, agent tools, APIs, etc., that the agent needs to accomplish the tasks of analyzing or understanding the objectives, analyzing the user activity data, generating an analysis summary for each objective in a natural language format, and so on. Furthermore, in some examples, multiple agents can be deployed and assigned different roles (e.g., performer, evaluator, team leader, subject matter expert, etc.), personas, knowledge bases, and/or any other characteristic suitable for enhancing, improving, automating, and/or contributing to the project workflow.

### Using Multiple AI Agents to Simulate Performer-Evaluator Interaction and Generate Constructive Feedback

The present disclosure includes example systems and methods for using multiple AI agents to simulate performer-evaluator interaction and generate constructive feedback, e.g., to enhance the quality, accuracy, and/or efficiency of workflows in a project pipeline.

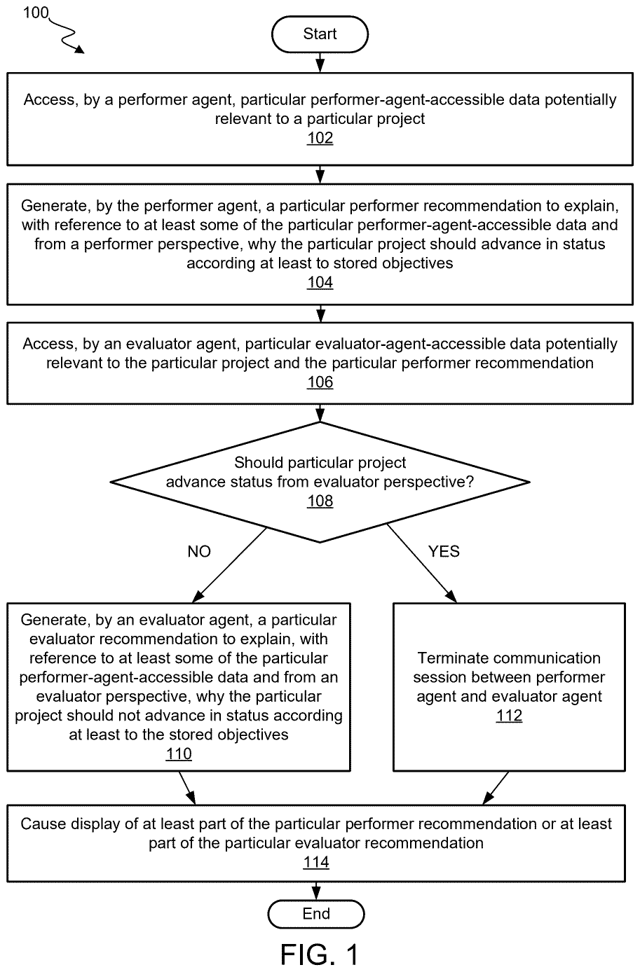

FIG. 1 illustrates a flow chart of an example process 100 that uses multiple AI agents to simulate performer-evaluator interaction and generate constructive feedback to automate project pipeline progression.

The process 100 begins at 102, where a performer agent of an example data management system accesses particular performer-agent-accessible data potentially relevant to a particular project.

In an example, the particular performer-agent-accessible data may include data submitted by one or more users (e.g., performer user). In a CRM application for instance, the example data management system may receive, via a user interface, data such as emails, telephone call transcripts, video call transcripts, meeting notes, and/or other information that can be used as support for an argument that one or more objectives of the particular objects are at least partially satisfied.

In an alternative or additional example, the particular performer-agent-accessible data may include data collected by the data management system. In a CRM application for instance, the data management system may monitor or scan stored communications of a performer or one or more other users (e.g., emails, chat history, etc.) for information that can potentially be imported into the data management system to satisfy (at least partially) the one or more objectives.

In an alternative or additional example, the particular performer-agent-accessible data may include data from other sources that is accessible to the performer agent (e.g., via a retrieval augmented generation (RAG) process, via an agent tool of the performer agent, via an API accessible to the performer agent, etc.). For instance, the performer agent may maintain a local agent data repository that stores historical project data of other projects and uses this data to learn possible actions that can help achieve certain objectives in the particular project.

At 104, the performer agent of the data management system generates a particular performer recommendation to explain, with reference to at least some of the particular performer-agent-accessible data and from a performer perspective, why the particular project should advance in status according at least to stored objectives. For example, the particular performer recommendation may argue that activity data (e.g., in the particular performer-agent-accessible data) justifies advancing status of one or more objectives of the particular project (e.g., advancing status from ‘Pending’ to ‘Partially Complete’ or from ‘Pending’ to ‘Completed’ or from ‘Partially Complete’ to ‘Completed’). Alternatively or additionally, the particular performer recommendation may argue that the activity data justifies advancing the particular project from a current stage to a next stage in a project pipeline.

In some examples, generating the particular performer recommendation at block 104 may include the performer agent generating a particular performer prompt to a large language model. The particular performer prompt may include a subset of the particular performer-agent-accessible data based at least in part on the particular project. In various implementations, the subset of the particular performer-agent-accessible data may include some or all of the particular performer-agent-accessible data. For instance, the subset of the particular performer-agent-accessible data may include various information such as objectives data, activity data (e.g., emails or any other relevant information accessible to the performer agent), instructions to analyze the activity data and objectives data from the performer perspective, and so on. The LLM may process the particular performer prompt and return an LLM response. In one embodiment, the LLM response may indicate or predict whether one or more objectives have been completed or partially completed in view of the activity data and the objectives data. In another embodiment, the LLM response may include an argument (e.g., from a performer's perspective) that explains why the information (e.g., activity data, objectives data) is sufficient to conclude that one or more objectives have been completed.

In some examples, process 100 involves the data management system configuring the performer agent to consume performer-agent-accessible data potentially relevant to a project and to generate a performer recommendation to explain, with reference to at least some of the performer-agent-accessible data and from the performer perspective, why the project should advance in status according at least to stored objectives. For instance, the performer agent can use an AI agent tool to retrieve data associated with the performer or the application (e.g., data about other projects or from other team members, etc.) to fine tune the performance of the LLM (e.g., via a RAG framework, etc.). Furthermore, configuring the performer agent to generate the performer recommendation may comprise configuring the performer agent to generate a prompt to a large language model that includes a subset of the performer-agent-accessible data based at least in part on the project. For instance, the data management system may configure the performer agent by providing additional relevant data (e.g., historical project data, etc.) to the performer agent so that the performer agent can incorporate the additional data its prompt to the LLM (e.g., via a RAG process, etc.).

In a particular example, configuring the performer agent to consume the performer-agent-accessible data comprises the data management system storing one or more access parameters for the performer agent. In various examples, the one or more access parameters may include a role, security profile, authentication key (e.g., private application selected key), and/or a stored token (e.g., assigned to application by the system that manages the data, for example with a keep alive timer or constraint) that performer agent can use to access (e.g., via an agent tool, API, etc.) an external data source to retrieve the additional data it needs to prompt the LLM.

In some examples, the performer agent accounts for a prior particular evaluator recommendation when generating the particular performer recommendation at block 104. For example, if a performer user submits additional data that could potentially address an issue indicated by the prior particular evaluator recommendation to support completion of a particular objective, the performer agent may account for that prior particular evaluator recommendation when it generates the current particular performer recommendation. For instance, in a CRM application scenario, if the prior evaluator recommendation suggested inquiring about a key decision maker, and the performance user sent an email to inquire about that information accordingly, the performance agent may then update its recommendation to indicate that the prior evaluator recommendation has been addressed by that sent email.

In some examples, the evaluator agent accounts for a prior particular performer recommendation when generating the prior particular evaluator recommendation. For instance, if the prior particular performer recommendation argued that a certain objective should be deemed completed, the prior particular evaluator recommendation may address that assertion by explaining why that certain objective is not completed or is only partially completed as well as optionally providing suggestions for obtaining additional information to achieve a completed status for that certain objective.

At 106, an evaluator agent of the data management system accesses particular evaluator-agent-accessible data potentially relevant to the particular project and the particular performer recommendation. In an example, the evaluator-agent-accessible data may include part or all of the performer-agent accessible data. For instance, the evaluator-agent-accessible data may include user activity data (e.g., emails, etc.) and/or other submitted or detected data associated with user actions that could potentially achieve (at least in part) one or more objectives. In an additional or alternative example, the evaluator-agent-accessible data may include data that is not included in the performer-agent accessible data. For instance, the evaluator-agent-accessible data may include data associated with the same user or other users (e.g., different performers and/or different projects), which could provide insights about whether the objectives of the particular project of the current performer user are sufficiently supported by currently available data.

In some examples, the evaluator-agent-accessible data comprises one or more sets of data that are not included in the performer-agent-accessible data. For example, in the context of a CRM application, the evaluator-agent-accessible data may include data that is only accessible to an evaluator user (e.g., sales manager) but not a performer user (e.g., sales representative), such as data associated with other sales representatives that the performer user does not have permission to access for privacy or security reasons, etc.

In some examples, the stored objectives may include one or more objectives specific to the evaluator agent. The one or more objectives may be specified (e.g., via a user interface) by an evaluator user. For example, the data management system may allow an evaluator user to enter certain objectives that are to be hidden from performer users (e.g., objectives that the evaluator wants to achieve across projects assigned to the evaluator without exposing those objectives to performers assigned to those projects). Such objectives, for example, may be analyzed by the evaluator agent against performer-agent-accessible data of a performer user. In this example, the analysis (e.g., evaluator recommendation) from the evaluator agent for these objectives may be displayed to the evaluator user (e.g., when the evaluator user accesses the data management system using his or her account credentials) without necessarily being displayed to the performer user (e.g., when the performer user accesses the data management system using his or her account credentials).

Similarly, in some examples, the stored objectives may include one or more objectives specific to the performer agent, and the one or more objectives specific to the performer agent may be specified (e.g., via a user interface) by a performer user. For instance, the performer user (e.g., sales representative) may want to assess or keep track of his or her own custom objectives even if they are not formally required by evaluators (e.g., sales managers) or other users (e.g., team leaders, etc.) responsible for setting required or preferred objectives.

At 108, the data management system determines whether a status of the particular project should be advanced from an evaluator perspective. For example, the evaluator agent of the data management system may prompt a LLM with the available particular performer-agent-accessible data and/or with at least a subset of the evaluator-agent-accessible data to determine whether this data is sufficient from an evaluator perspective to advance the project. If yes, process 100 proceeds to block 112. If no, process 100 proceeds to block 110.

At 110, the evaluator agent of the example data management system generates a particular evaluator recommendation to explain, with reference to at least some of the particular performer-agent-accessible data and from an evaluator perspective, why the particular project should not advance in status according at least to stored objectives. In some examples, generating the particular evaluator recommendation at block 110 includes the evaluator agent of the data management system generating a particular evaluator prompt to a large language model that includes a subset of the evaluator-agent-accessible data based at least in part on the particular project.

In some examples, the particular evaluator prompt includes at least part of the particular performer recommendation. For example, the evaluator agent may incorporate the particular performer recommendation in its prompt to the LLM so that the particular evaluator recommendation can address justification arguments in the performer recommendation (e.g., explain why the justification arguments are not accepted or insufficient to address the objective completely). Advantageously, with the present method, the performer agent and the evaluator agent use LLMs to comprehend and address customizable natural language content describing the various objectives, user activity data, and/or each other's arguments, so that they can address all the available information or arguments in a nuanced manner to provide constructive feedback to users of the data management system.

In some examples, the process 100 includes the data management system configuring an evaluator agent to consume evaluator-agent-accessible data potentially relevant to the project and the performer recommendation and to generate an evaluator recommendation to explain, with reference to at least some of the performer-agent-accessible data and from the perspective of the evaluator, why the status of the project should not be advanced according at least to stored objectives. In one or more examples, configuring the evaluator agent to consume the evaluator-agent-accessible data comprises storing one or more access parameters for the evaluator agent, where the one or more access parameters for the evaluator agent are different than the one or more access parameters for the performer agent. In one or more examples, configuring the evaluator agent to generate the evaluator recommendation comprises configuring the evaluator agent to generate a prompt to a large language model that includes a subset of the evaluator-agent-accessible data based at least in part on the project.

At 112, the data management system terminates a communication session between the performer agent and the evaluator agent. In an example, the termination of the communication session (e.g., back-and-forth recommendations between the performer agent and the evaluator agent in the current stage, etc.) at block 112 may be based on the particular evaluator recommendation of block 110 indicating that the objectives of the current stage are approved or completed. Alternatively or additionally, in an example, the data management system may decide to terminate the communication session even if not all of the objectives are completed if a threshold number of back-and-forth communications between the performer agent and the evaluator agent is reached. For instance, if the performer agent and the evaluator agent are unable to reach an agreement over the sufficiency of available data to prove that all the objectives are completed, the data management system may allow the user to progress to the next stage of the particular project pipeline (e.g., by ignoring the remaining incomplete or partially complete objectives of the current stage of the pipeline).

Similarly, in some examples, process 100 includes the data management system terminating a prior back-and-forth communication session between the performer agent and the evaluator agent based at least in part on determining by the evaluator agent that a prior status is satisfied.

Alternatively or additionally, in some examples, process 100 includes the data management system terminating a prior back-and-forth communication session between the performer agent and the evaluator agent based at least in part on a number of particular evaluator recommendations in the prior back-and-forth communication session satisfying a threshold. For instance, the data management system may set a maximum number of back-and-forth performer-evaluator recommendations (i.e., the threshold) at which the data management system may allow a user to force progression to a next stage of the project pipeline even if one or more of the objectives is not completed. Thus, in some scenarios, the data management system may allow progression in the pipeline even if not all the objectives of a current stage are completed to avoid potential bottlenecks at a certain stage of the pipeline.

At 114, the data management system causes display of at least part of the particular performer recommendation and at least part of the particular evaluator recommendation. For example, the data management system may display the particular performer recommendation as a chatbot message or other natural language content to provide to the user a justification argument that supports a conclusion that the performer has performed enough actions to achieve a certain objective, as well as a similar message or natural language content output corresponding to the evaluator recommendation which offers an argument from a different perspective that the objective is not yet completely achieved and/or constructive feedback such as suggestions for what the performer user can do to complete the objective.

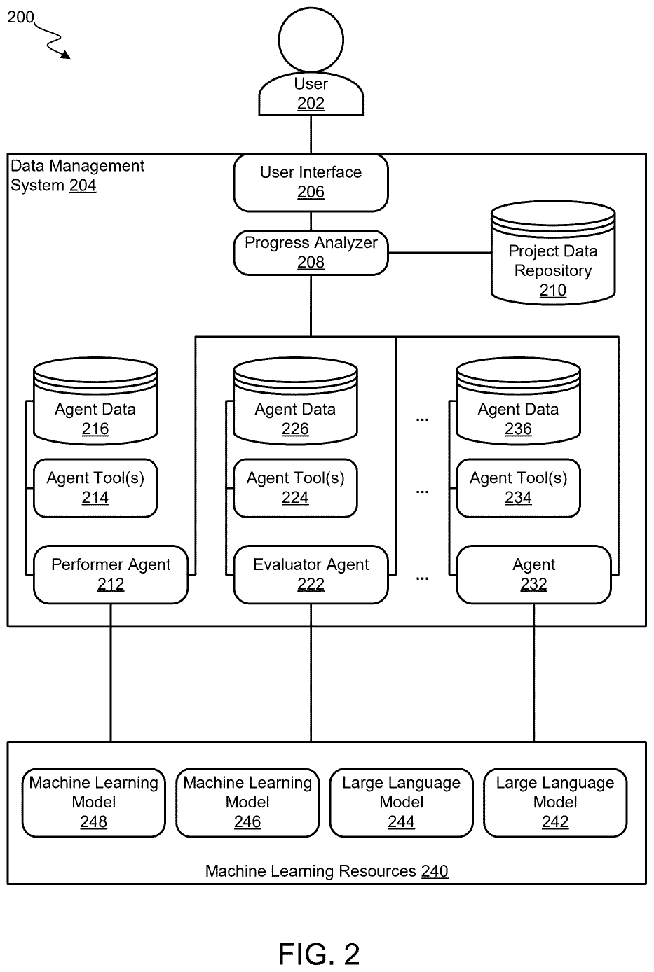

FIG. 2 illustrates a system diagram 200 showing an example data management system 204 that uses multiple AI agents to simulate performer-evaluator interaction and generate constructive feedback to automate project pipeline progression. In the illustrated example, the data management system 204 includes a user interface 206, a progress analyzer 208, a project data repository 210, a performer agent 212 configured to access one or more agent tools 214 and agent data repository 216, an evaluator agent 222 configured to access one or more agent tools 224 and agent data repository 226, and an agent 232 configured to access one or more agent tools 234 and agent data repository 236. Furthermore, in the illustrated example, AI agents 212, 222, and/or 232 may be configured to access one or more resources from machine learning (ML) resources 240. The ML resources 240 may include one or more LLMs, exemplified by LLMs 242 and 244, and one or more other ML models, exemplified by ML models 246 and 248.

It is noted that the data management system 204 may alternatively include fewer or more AI agents than the three agents 212, 222, and 232 shown, depending on various applications of the data management system 204. It is also noted that the ML resources 240 may alternatively include fewer or more LLMs and/or ML models than the two LLMs 242, 244 and the two ML models 246, 248 shown.

In the scenario of the system diagram 200, a user 202 interacts with the data management system 204 via a user interface 206. To that end, the user interface 206 may include any combination of hardware and/or software components configured to receive inputs and provide outputs to the user 202, such as a graphical user interface (GUI) or any other type of user interface.

The progress analyzer 208 includes any combination of hardware and/or software components configured to process and/or analyze project data including user inputs received via user interface 206, outputs (e.g., natural language AI generated summaries, justification arguments, objectives analysis, progress assessments, etc.) provided via user interface 206. The progress analyzer 208 may also store and/or retrieve data from project data repository 210 to support the various functionalities of the data management system. The progress analyzer 208 may also configure and/or use one or more AI agents, such as any of performer agent 212, evaluator agent 222, and/or agent 232, to facilitate performing the various pipeline management processes described herein. For example, the progress analyzer 208 may use performer agent 212 to generate a performer recommendation that attempts to argue that objectives of a current stage of a particular project were achieved, and the evaluator agent 222 to generate an evaluation recommendation that attempts to argue that the objectives (at least in part) were not achieved and possibly constructive feedback or suggestions for additional actions to satisfy the remaining objectives of the current stage. The progress analyzer 208 may then aggregate and/or output (e.g., via the user interface 206) the various recommendations, summaries, suggestions, and/or any other information from the agents 212, 222, and/or 232, that is relevant to progression to a next stage of the pipeline.

The data repositories 210, 216, 226, and/or 236 may include any combination of hardware components, software components, and/or any other data storage system configured to store data and provide access to stored data to various respective components of the data management system 204. The stored data can be stored in a variety of different data storage media and in any suitable format, such as database files, other file formats, and in any computing system, such as remote data storage servers, local data storage devices, and so on.

The project data repository 210 may store data about one or more projects or processes managed by the data management system 204. For example, the project data repository 210 may store a listing of various projects assigned to various performer users, a sequence of stages to advance each type of project to completion, objectives to be achieved at each stage of the project pipeline, and so on. In some examples, the various stages and/or objectives associated with a particular project can be customizable and/or defined (e.g., in a natural language format) by certain user types or roles (e.g., evaluators, team leaders, etc.) associated with the particular project.

Each of the performer agent 212, the evaluator agent 214, and/or the agent 232 may include any combination of hardware and/or software components configured to implement an AI agent that has certain configuration parameters and assigned functionalities (e.g., performer role, evaluator role, etc.). To that end, each of the agents 212, 222, 232 may be configured to access a respective one or more agent tools and/or a respective agent data repository. For example, the performer agent 212 may be configured to use one or more agent tools 214 in any permissible manner to facilitate performing the performer functions assigned to the performer agent 212.

By way of example, the agent tool(s) 214 may include tools for accessing software services such as email applications, chat applications, video conferencing applications, and/or other communication applications of the user 202 to obtain data from these applications and/or to assist with initiating communication actions (e.g., draft email, draft meeting schedule, etc.) with the aim of achieving one or more objectives and/or performing actions suggested in an evaluator recommendation suggested by the evaluator agent 222.

The performer agent 212 may also store or retrieve data that is specifically accessible to the performer agent 212 via the agent data repository 216. For example, the data repository 216 may store prompt templates for the performer agent 212 to configure LLM 242 and/or LLM 244 according to a performer persona, knowledge base, etc., that is suitable for generating a performer recommendation or other performer action associated with the project pipeline. As another example, the performer agent 212 may also train and/or use one or more ML models (e.g., ML model 246 and/or 248) to improve its own capabilities (e.g., learn patterns from evaluator recommendations or other agent comments related to the functionality of performer agent 212).

Similarly, the agent tool(s) 224 and agent data repository 226 can be configured to support specific functions (e.g., evaluator role) of evaluator agent 222 with respect to the project pipeline. And, similarly, the agent tool(s) 234 and agent data repository 236 can be configured to support specific functions of agent 222.

In some applications, the data management system 204 may use any number of performer agents, evaluator agents, and/or other types or combinations of AI agents suitable for various project pipelines. By way of example, multiple performer agents can be used to automate different performer functions separately (e.g., generate justification argument, perform actions suggested by an evaluator agent, monitor user communications to find additional data that is potentially relevant to one or more objectives, etc.). As another example, multiple evaluator agents can be used to automate different evaluator functions separately (e.g., evaluate without knowledge of historical data associated with other users, evaluate in view of historical data, evaluate in consideration of particular user performance relative to other users, etc.). Additionally or alternatively, in some applications, a different type of agent role can be defined (e.g., team leader, department head, peer reviewer, etc.) and integrated in the data management system 204 to contribute to the project pipeline.

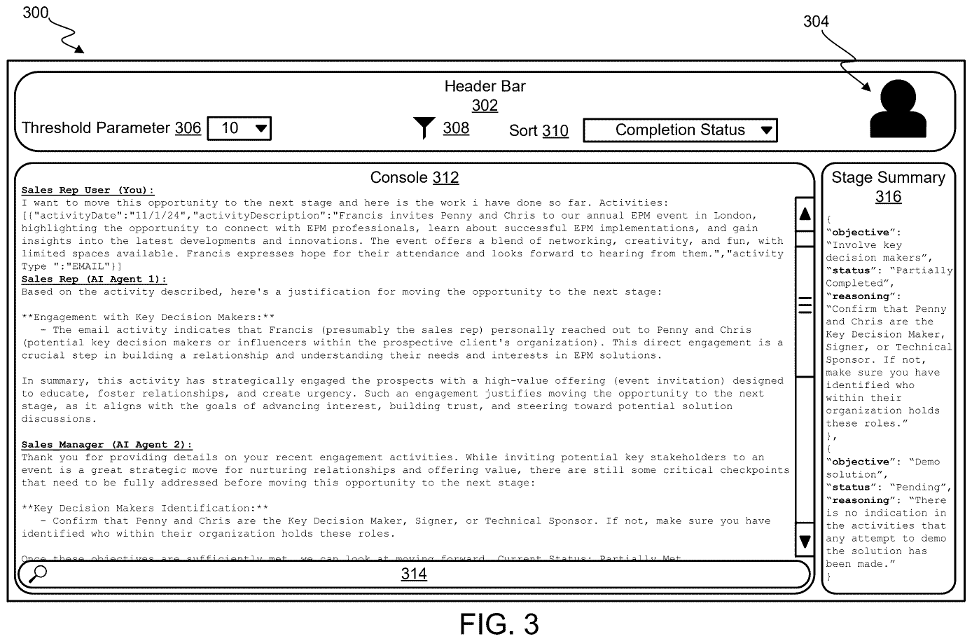

FIG. 3 illustrates a diagram of an example user interface (UI) 300 showing interactions with multiple AI agents to automate objectives-based progression in an example sales pipeline management application. In one embodiment, the UI 300 may be an example GUI of a sales pipeline management application that implements the data management system 204 and/or any part of the system 200.

In the illustrated example, the UI 300 includes a header bar 302 which is a UI element that displays one or more parameters and/or other information relevant to a user session of a user account that is currently accessing the UI 300. For example, as shown, the header bar 302 includes an account profile image 304 which may indicate an account profile of a user that currently has an authenticated user session with the system of UI 300. The header bar 302 may also include a threshold parameter 306 (e.g., maximum number of back-and-forth recommendations between a performer agent and an evaluator agent, etc.), a filter UI element 308 (e.g., for filtering objects or projects or other data slices being analyzed or displayed in the UI 300, etc.), and a sort parameter 310 (e.g., for selecting a metric for which the data is to be sorted).

As shown, the UI 300 may also include a console 312, which may include a GUI element that displays messages communicated between a user (e.g., ‘Sales Rep User (You)’), and one or more AI agents (e.g., ‘Sales_Rep (AI_Agent 1)’, ‘Sales Manager (AI Agent 2)’). In the illustrated example, the UI 300 also includes an input element 314 that the user of UI 300 can use to input requests or commands or messages to the data management system. For example, the user may submit an input like ‘I want to move this opportunity to the next stage and here is the work I have done so far’. In some implementations, the system of UI 300 may augment the user input by parsing relevant user activity data (e.g., the email details in the illustrated example) and combining the parsed data with the user's input prompt. In other implementations, the user may input the user activity data via the input element 314 or otherwise indicate it to the system (e.g., via one or more other UI elements).

In the illustrated example, the UI 300 also includes a stage summary 316 GUI element, which may display a summary of remaining objectives in a current stage of the pipeline including the objective itself, a status of the objective (e.g., partially completed, pending), and/or reasoning (e.g., evaluator recommendation) for the status assigned to objective. In some examples, most of the displayed information in the console 312 and/or the stage summary 316 may be automatically generated and/or automatically updated every time the user of UI 300 submits new data using the input UI element 314.

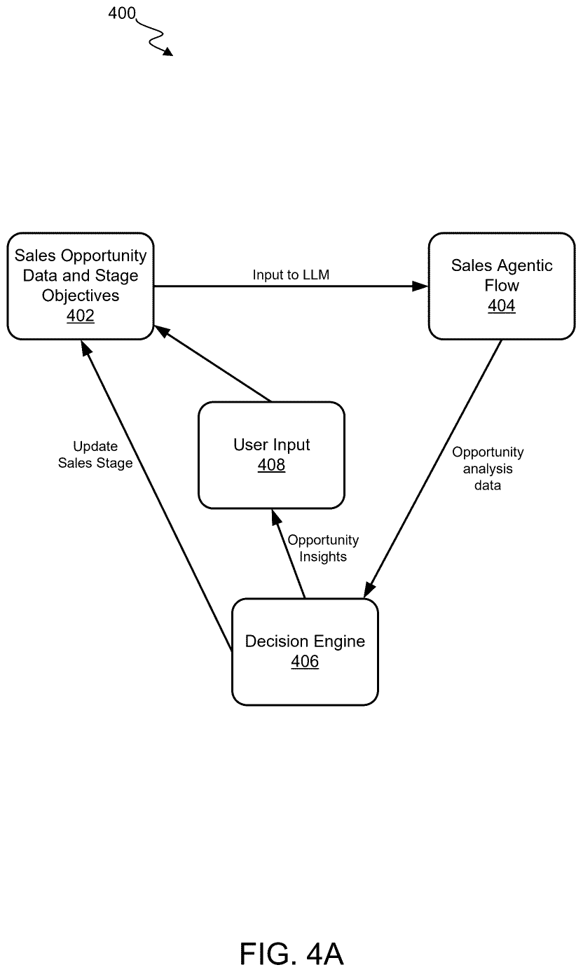

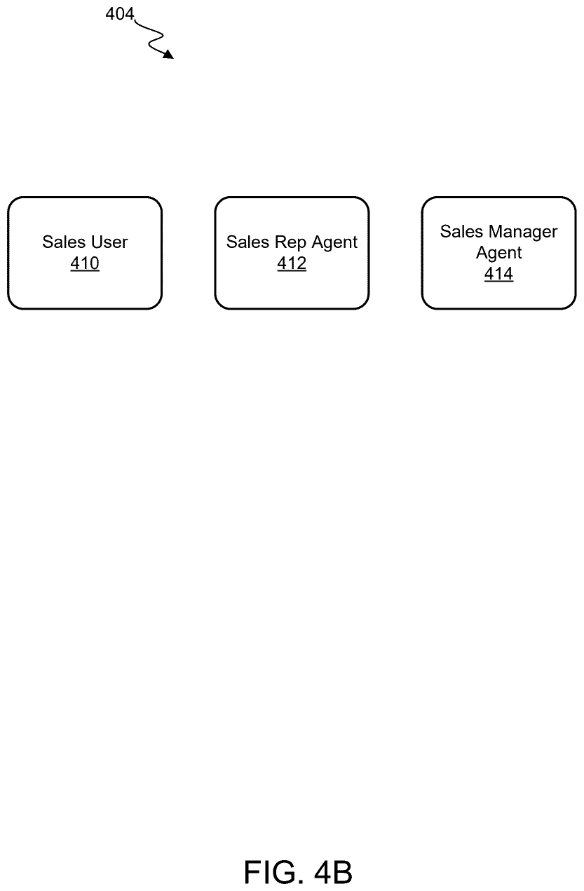

FIG. 4A illustrates a system diagram 400 showing an example sales pipeline management system that uses multiple AI agents to automate stage progression. In the illustrated example, block 402 may indicate accessing individual opportunity data (e.g., project data) and/or objectives for a current stage in the sales pipeline. In one embodiment, opportunity data (e.g., project data) may be different for each opportunity. In one embodiment, stage objectives of a particular stage in the pipeline and/or the number of stages for an opportunity may be the same for some or all the opportunities (e.g., projects) in the sales pipeline. In some examples, the stage objectives may be defined by a sales leadership team or user as a guideline of what should be achieved before a sales representative user moves an opportunity to a next stage of the sales pipeline.

An example configuration where two stages are defined and possible objectives defined for each stage is as follows. In this example, the first stage may be defined as “Understand” and a second stage of the Pipeline may be defined as “Presentation.” For the first stage, the objectives defined by the sales leadership user may include: “Research business”, “Identify Requirements”, and “Have a discovery call”. For the second stage, the objectives defined by the sales leadership user may include: “Invoke key decision makers”, “Demo solution”, and “Understand post demo feedback.” Note that, in some examples, the various stage and objective definitions may be input to the system 400 in a natural language format.

In some examples, the opportunity data (e.g., project data) may include a combination of relatively static data (or any other data), such as associated customer, target products, customer industry, etc. In an example, the opportunity data may include transactional data representing activities and/or tasks performed or to be performed by a sales representative user (or to be automated) to progress the opportunity. In an example, the opportunity data may include data related to phone calls, emails, notes taken by one or more sales representative users, other customer communications, research done, and/or structural data such as key client contacts, contact roles, etc.

Block 404 or sales agent flow 404 represents one or more system components that implement the agentic flow (e.g., AI agent(s) functionality). For example, the sales agentic flow 404 may involve using two LLM agents including a first LLM agent acting as a sales representative (e.g., performer agent 212) and a second LLM agent acting as a sales manager user (e.g., evaluator agent 222). The two LLM agents may have access to the opportunity data 402 and/or may generate (e.g., set) LLM prompts to facilitate making a decision about whether the data provided has sufficient evidence of meeting one or more sales objectives. The output of the sales agentic flow 404 may act as input to decision engine 406.

FIG. 4B illustrates example components of the sales agentic flow 404 of FIG. 4A. As shown, the sales agentic flow involves a sales user at 410, a sales representative agent 412, and a sales manager agent 414. The sales user 410 may represent a performer user (e.g., human sales representative, etc.), who may also be referred to as an owner of the opportunity. In some examples, the sales user 410 may be responsible for performing and/or reporting one or more performer activities, such as engagements with a prospective client and ultimately closing the opportunity or project. In an example agentic flow system, the sales user 410 may be a performer user (e.g., similar to user 202) that passes data about work done so far to advance the opportunity and/or data about the objective that is being targeted for completion.

The sales representative agent 412 represents a LLM agentic workflow agent (e.g., AI agent, performer agent 212, etc.) configured to invoke or prompt a LLM (e.g., LLM 242, 242, etc.) to generate (e.g., create) one or more justification arguments that the user actions performed and/or reported are sufficient to mark a stage objective as complete. In an example, the sales representative agent 412 (e.g., performer agent 212) may present the generated justification arguments to the sales manager agent 414.

The sales manager agent 414 represents an AI agent (e.g., evaluator agent 222) configured to engineer prompts with knowledge of a sales manager persona and/or understanding of stage objectives that should be completed to advance the opportunity to a next stage. In an example, the sales representative agent 412 is configured to pass a justification argument (e.g., performer recommendation) to the sales manager agent 414 for approval of the justification (i.e., agreement by the sales manager agent 414 that the objective is completed). In this example, the sales manager agent 414 may use a LLM (e.g., LLM 242, 244, etc.) to analyze the justification of the sales representative agent 412 along with the stage objective (and/or data describing the user actions of the sales representative) for analysis from a perspective of the sales manager agent (e.g., evaluator agent 222). In an example, the sales manager agent 414 may provide feedback (e.g., constructive feedback, evaluator recommendation, etc.) if the LLM response to the prompt from the sales manager agent 414 indicates that the stage objective is not met or only partially met. Alternatively, for example, if the LLM response indicates that the stage objective is met, then the sales manager 414 may indicate that the opportunity is approved (e.g., by outputting feedback or an evaluator recommendation that includes an approval comment, etc.).

An example of back-and-forth communication between the sales user 410, the sales representative agent 412, and the sales manager agent 414 is depicted in console 312 of UI 300. As depicted in FIG. 3, the justification and feedback arguments are presented in console 312 in a natural language format and are worded from the respective perspectives of a sales representative and a sales manager.

Returning now to FIG. 4A, the system 400 also includes a decision engine 406. The decision engine 406 is configured to receive the output from the sales agentic flow 404 (e.g., opportunity analysis data). The decision engine 406 includes any combination of hardware and/or software components configured to decide, based on the opportunity analysis data from the sales agentic flow 404, whether to progress the opportunity to a next stage of the sales pipeline or to operate as an interruption mechanism, e.g., for guiding (e.g., by forwarding the sales manager agent feedback, etc.) the sales representative user to provide additional data that can potentially complete the remaining objectives of the current stage before progressing the opportunity to the next stage of the sales pipeline. In an example, the decision engine 406 is configured to manage an iterative process so that the sales agentic flow 404 is executed to check all the objectives for the current stage of the sales pipeline. For example, the decision engine 406 may generate a stage summary (e.g., stage summary 316) or any other output that aggregates and/or summarizes the status of each remaining objective in the current stage of the sales pipeline.

In an example, at block 408, the decision engine 406 may identify one or more objectives of the current stage as partially or completely pending (i.e., not completed). In this example, the decision engine 406 may output a request (e.g., via a user interface) to the sales representative user to provide additional data to the opportunity so that the decision engine 406 can reconsider whether it should decide to advance the opportunity to the next stage. Thus, in some examples, the user input 408 may cause the system 400 to repeat the process of blocks 402-408 one or more times until the decision engine 406 determines that all the objectives of the current stage are completed before allowing the sales representative user to advance the opportunity to the next stage in the sales pipeline. In alternative examples, the decision engine 406 may allow the opportunity to advance to the next stage even if one or more of the objectives of the current stage are not completed (e.g., partially completed or pending), e.g., after a threshold number (e.g., 10, 15, etc.) of iterations (i.e., repetitions of blocks 402-408) are performed.

### Example Applications for Using Multiple AI Agents to Automate and Improve Workflows

Example applications of a data management system (e.g., data management system 204, etc.) that uses multiple AI agents to automate and improve workflows and/or pipeline management will now be described in greater detail. As noted earlier, the example systems and methods of the present disclosure can be used in a variety of applications, such as CRM applications, mentorship applications (e.g., mentor is evaluator, mentee is performer), job application software (e.g., job applicant is performer, recruiter is evaluator), entertainment production software (e.g., entertainer or comedian as performer, producer or show director as evaluator), among other examples.

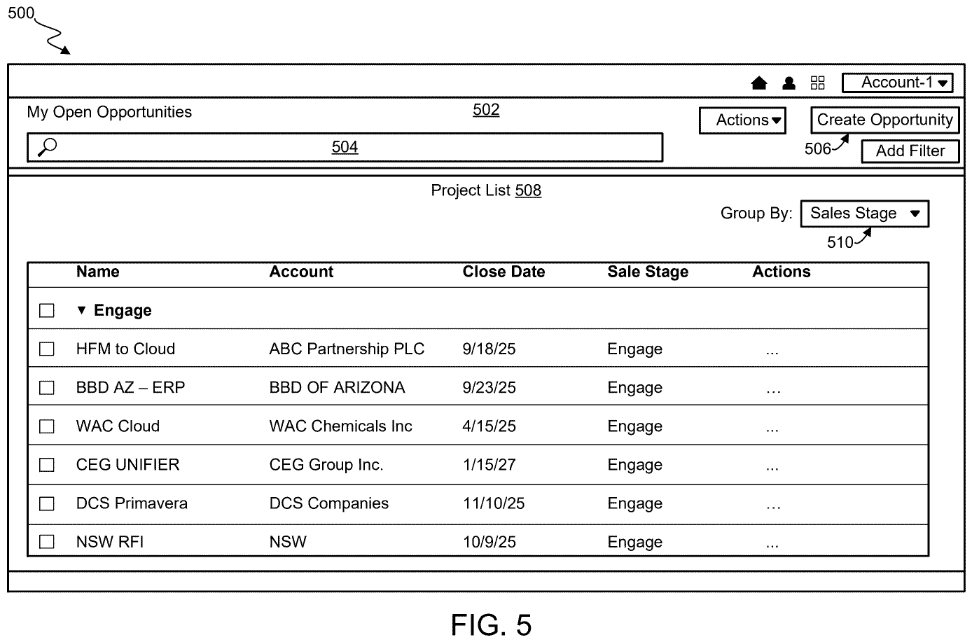

For the sake of example, FIGS. 5-14 illustrate an example scenario or use case of an example CRM application that implements at least some aspects of the various systems (e.g., data management system 204, etc.) and methods described herein.

FIG. 5 illustrates a diagram of an example user interface 500 of an example CRM application showing a list of projects (e.g., opportunities) assigned to a particular performer user (e.g., sales representative). The UI 500 includes a header bar 502, which is a GUI element that a user of the CRM application can use to select certain actions (e.g., selecting button 506 to create a new project or opportunity) and/or refine the information displayed in project list 508 (e.g., using input element 504 to request filtering the project list 508, etc.). In some examples, the input element 504 is configured to receive user request input in a natural language format. For example, an AI agent (e.g., agent 232) can be used to understand the user input and respond to the user appropriately. The project list 508 is a UI element that lists one or more projects (e.g., opportunities) assigned to the user of UI 500 (e.g., ‘HFM to Cloud’). The project list 508 may include an input element 510, which the user can use to adjust how his or her projects are grouped in the project list 508. For example, the user can select ‘Sales Stage’ in the input element 5510 to group the projects by their current stage (e.g., ‘Engage’, ‘Evaluate’, ‘Close’, etc.) in the sales pipeline. In some examples, the various stage definitions may be defined by a senior user (e.g., manager, etc.) or other user having an administrator role in the CRM application.

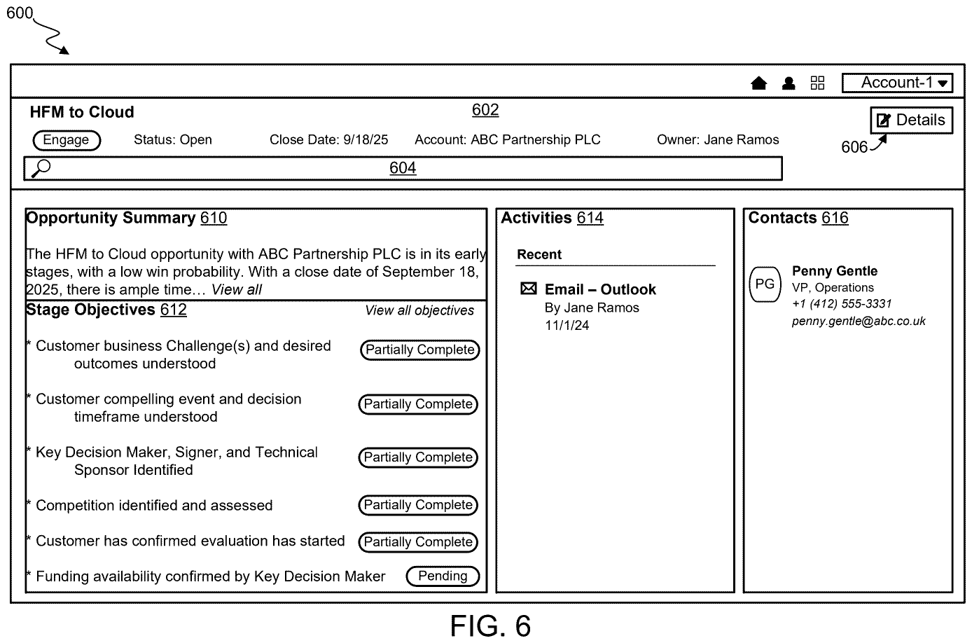

FIG. 6 illustrates a diagram of another example user interface of the CRM application showing a particular project (e.g., opportunity) assigned to the particular performer user (e.g., ‘Jane Ramos’). For example, the CRM application may be configured to navigate from the view in UI 500 to the view in UI 600 if the user selects the first project or opportunity in the project list 508 of UI 500 (e.g., ‘HFM to Cloud’).

In the illustrated example, the UI 600 includes a header bar 602, which is GUI element that displays information about the particular project or opportunity (e.g., name, current stage, status, close date, account, owner or performer user, etc.). The header bar 602 may also include a selectable button 606 which the user can use to edit details of the project or opportunity, e.g., such as the details displayed in the header bar 602. The header bar 604 also includes an input element 604, which the user can select to request or trigger certain actions in the UI 600 (e.g., add new activity, update contact information, request moving to the next stage in the pipeline, etc.). In some examples, the system of the UI 600 can receive these user requests in a natural language format. For example, the system can use an LLM (e.g., via agent 232, etc.) to understand and/or respond to the user request received via input element 604.

The UI 600 also includes several GUI sections for displaying information pertaining to the project or opportunity. For example, the UI 600 includes an opportunity or project summary pane 610, which displays an AI generated summary of the current progress of the project. The project summary 610 may be generated by an AI agent (e.g., agent 232, etc.) based on the current progress of the various objectives in all stages of the pipeline, feedback or analysis from other agents (e.g., agents 212, 222) about each of the objectives, and/or other information. In some examples, project summary 610 can be dynamically and automatically updated by the AI agent whenever new information becomes available (e.g., when a new activity or other data relevant to the objectives becomes available, etc.).

As shown, the UI 600 also includes stage objectives pane 612, which displays a list of the objectives in the current stage (e.g., ‘Engage’) of the pipeline. In some examples, the stage objectives list 612 filters out any stage objectives that are completed, i.e., by only displaying remaining objectives which have a ‘partially completed’ or ‘pending’ (e.g., no progress yet) status as depicted in FIG. 4. The stage objectives 612 may also include a selectable link (e.g., ‘View all objectives’) which the user can select to access an expanded or detailed view of the various objectives and their statuses.

As shown, the UI 600 may also include an activities pane 614, which is a GUI element that displays one or more activities submitted, detected, input, etc., by the user of UI 600 and which provide data or information that is potentially relevant to the objectives of the current stage (and/or other stage) of the pipeline. For example, as depicted, the activities 614 include an email (e.g., ‘By Jane Ramos’, dated ‘Nov. 1, 2024’).

As shown, the UI 600 may also include a contacts pane 616, which is a GUI element that displays contact information of contacts that are potentially relevant to the project or opportunity (e.g., ‘Penny Gentle’). In some embodiments, an example system of the UI 600 may update the information in the contacts 616 automatically using one or more AI agents (e.g., performer agent 212, evaluator agent 222, agent 232, etc.). For example, when the user submit the email item in the activities list 614, the performer agent 212 can parse the email to identify ‘Penny Gentle’ as an important contact for this opportunity and then collect her contact information (e.g., from email or from other data sources) automatically and create an entry in the contacts 616 automatically (or prepare a draft contact entry for the user to confirm).

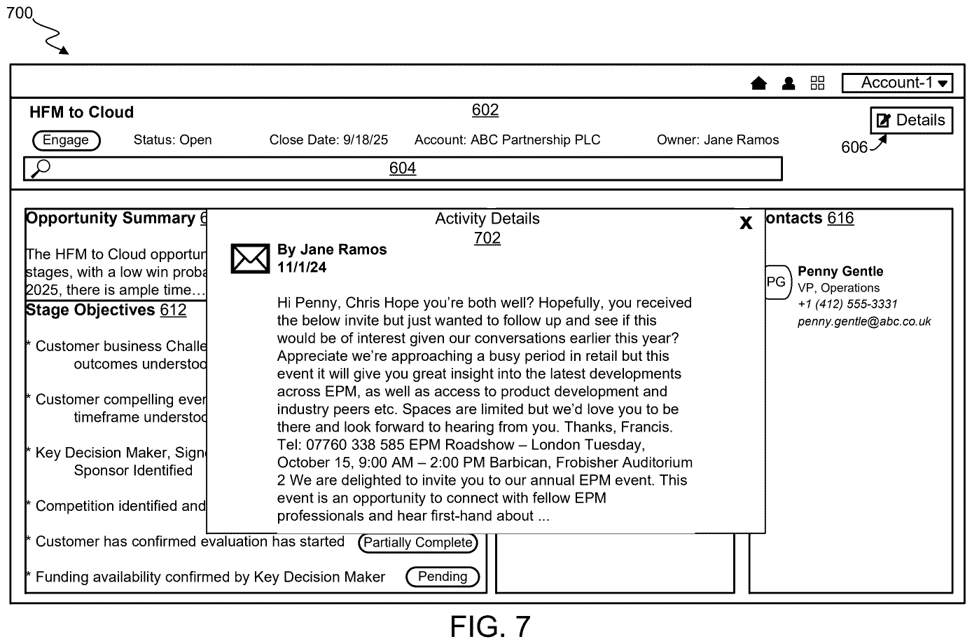

FIG. 7 illustrates a diagram of another example user interface 700 of the CRM application showing activity details of a particular activity associated with the particular project. By way of example, the user of UI 600 can navigate to the view of UI 700 by selecting the email item in the activities 614 pane of UI 600. As depicted in UI 700, the system may display activity details 702 in a GUI element which may be overlaid on other sections of the GUI 700 and may present the activity details 702 of the selected item in a uniform format. Thus, an example system of UI 700 may aggregate and organize relevant activity data items in a uniform manner to facilitate quick review for the user.

Further, as shown, the example system (e.g., data management system 204) is able to comprehend and extract useful information (e.g., by using the performer agent 212, evaluator agent 222, etc.) from the natural language content of any of the items of user activity in the activity list 614, e.g., by using the NLP capability of LLMs and/or other machine learning functionalities to understand the natural language content of the user activity items (e.g., emails, etc.) and the natural language descriptions of the objectives (which can be customizable) and automatically perform tasks that would otherwise be difficult to reliably perform manually every time new information becomes available (e.g., update project summary 610, update objective statuses like ‘Partially Complete’, ‘Pending’, etc.).

In some scenarios, where there is a large amount of user activity data, a sales representative user or performer (e.g., ‘Jane Ramos’) might miss some nuanced details that address one or more objectives if the user analyzes the data manually. Advantageously, in these scenarios, an AI agent (e.g., performer agent 212) may instead assist the user by performing data analysis automatically and quickly for each objective every time new user activity data becomes available to keep objective status information (and overall project summary information) more reliable and/or up to date.

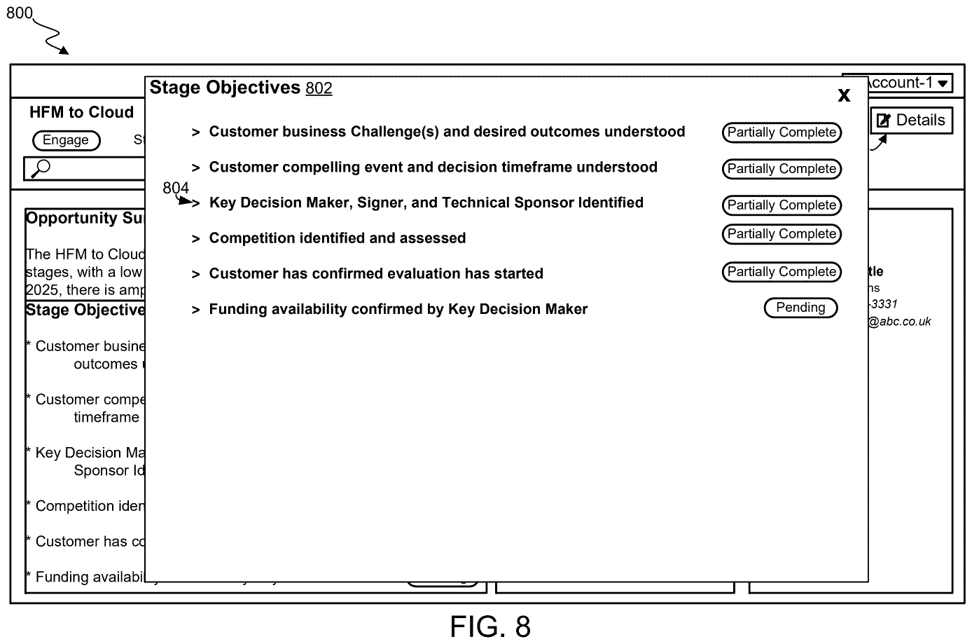

FIG. 8 illustrates a diagram of another example user interface 800 of the CRM application showing stage objectives associated with the particular project. For example, the system of UI 600 may navigate to UI 800 when the user selects the ‘View all Objectives’ selectable link in the stage objectives 612 pane of UI 600. As shown in FIG. 8, the UI 800 displays a state objectives list 802 GUI element (e.g., GUI form overlaid on other sections of the UI 800) to provide a more detailed or complete view of the stage objectives. As shown, the stage objectives GUI 802 includes selectable links (e.g., ‘>’) next to each objective, which the user can select to expand or collapse details about one specific objective. For example, selectable element 804 can be selected to display details about the objective of ‘Key Decision Maker, Signer, and Technical Sponsor Identified’.

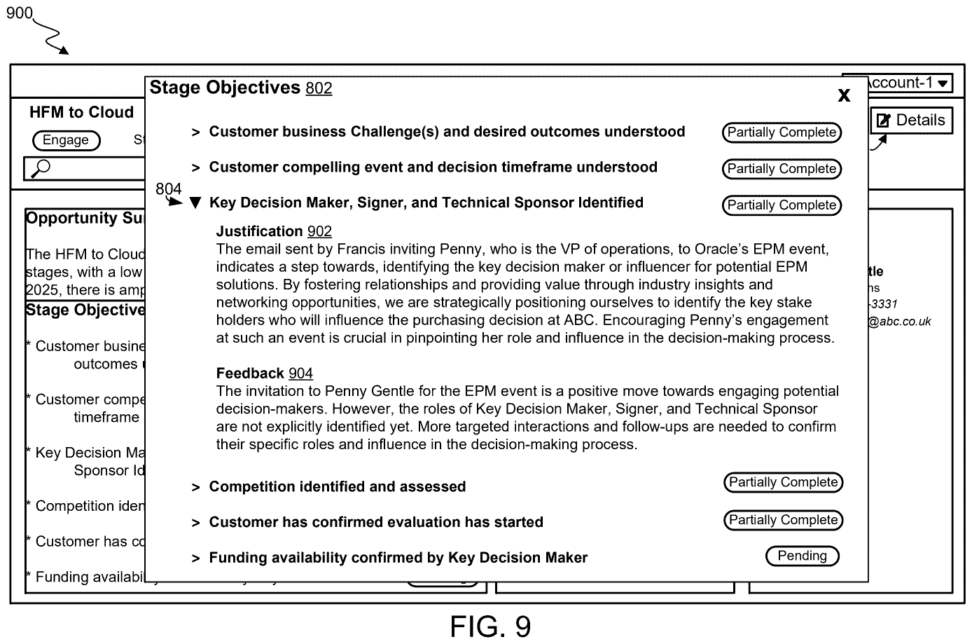

FIG. 9 illustrates a diagram of another example user interface 900 of the CRM application showing a particular performer recommendation 902 (e.g., justification 902) generated by an example performer agent (e.g., performer agent 212) and a particular evaluator recommendation 904 (e.g., feedback 904) generated by an example evaluator agent (e.g., evaluator agent 222). For example, a system of UI 800 may navigate the user from UI 800 to UI 900 when the user selects the selectable link 804. In some examples, the system generates a justification (or performer recommendation) for why an objective should be marked complete by the performer agent 212 analyzing each objective against the available data. Similarly, the system can generate and/or update feedback (or evaluator recommendation) for multiple objectives every time new data becomes available by the evaluator agent 222 analyzing each objective against the available data.

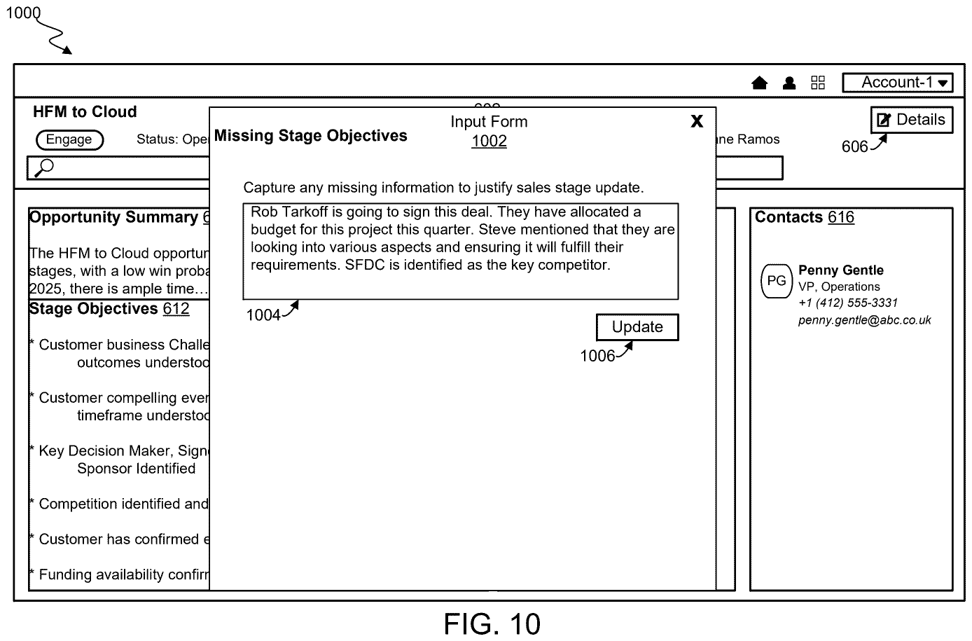

FIG. 10 illustrates a diagram of another example user interface 1000 of the CRM application showing an input form 1002 for receiving information about the particular project. In a first example, the UI 600 may navigate to the UI 1000 when the user requests that he enter new information via the input element 604. For instance, the user can enter a natural language request like ‘Add new activity information’ or the UI 600 may recommend an option to add new information. In a second example, the UI 600 may navigate to the UI 1000 if the user attempts to move to the next stage of the pipeline while one or more objectives are not yet completed. For instance, if the user submits (via input element 604) a request like ‘Move to the next sales stage’, the system of UI 600 may instead navigate the user to UI 1000 and display the input form 1002 which directs the user to provide more information first (e.g., ‘Capture any missing information to justify sales stage update.”) before advancing to the next stage.

As shown, the input form 1002 may be overlaid on at least part of the UI 1000, and may include an input field 1004 and an update button 1006. The input field 1004 may be a GUI element configured to receive input (e.g., text input, voice input, etc.) from the user. The update button 1006 may be a selectable GUI element that the user can select to instruct the system of UI 1000 to begin processing the input in the input field.

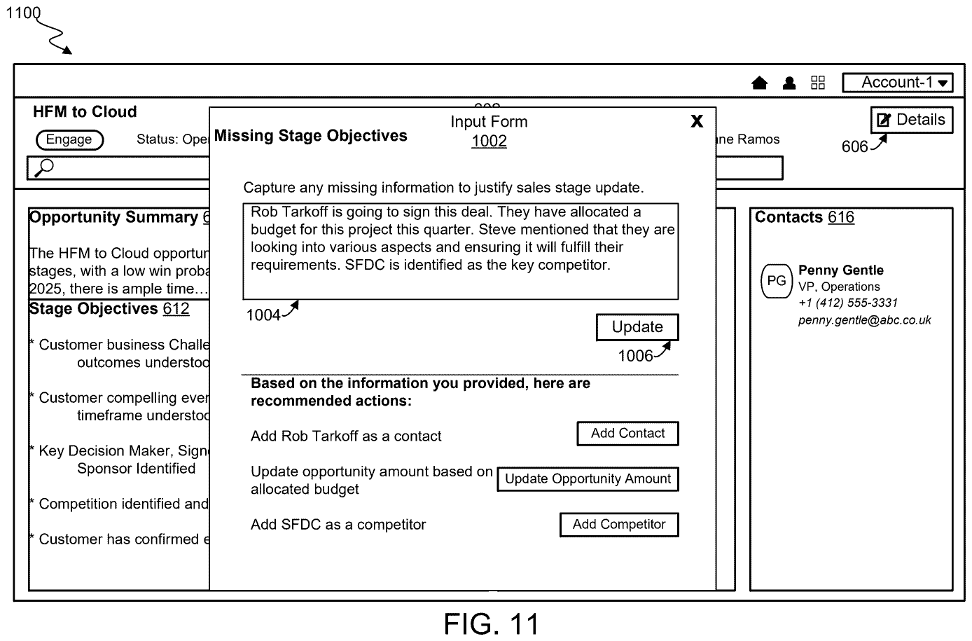

FIG. 11 illustrates a diagram of another example user interface 1100 of the CRM application showing example recommendations (e.g., add contact, update opportunity amount, add competitor) generated using one or more AI agents based on the information indicated in the input form 1002. The UI 1000 may navigate the user to UI 1100 when the user selects the update button 1006.

In the illustrated example, the system may process the new data received in the input field 1004 automatically (e.g., via the performer agent 212) to determine that ‘Rob Tarkoff’ is a new contact who may be relevant to the project or opportunity. If the user selects the ‘Add Contact’ button, for example, the performer agent 212 may create a new entry in the contacts list 616. In some embodiments, the performer agent 212 and/or another AI agent (e.g., agent 232) can perform this task and can perform other related tasks (e.g., search for title, phone number, email address, etc., of Rob Tarkoff) automatically using the newly received data and/or other data sources accessible to the AI agent (e.g., via an agent tool like a web browser API, address directory API, etc.).

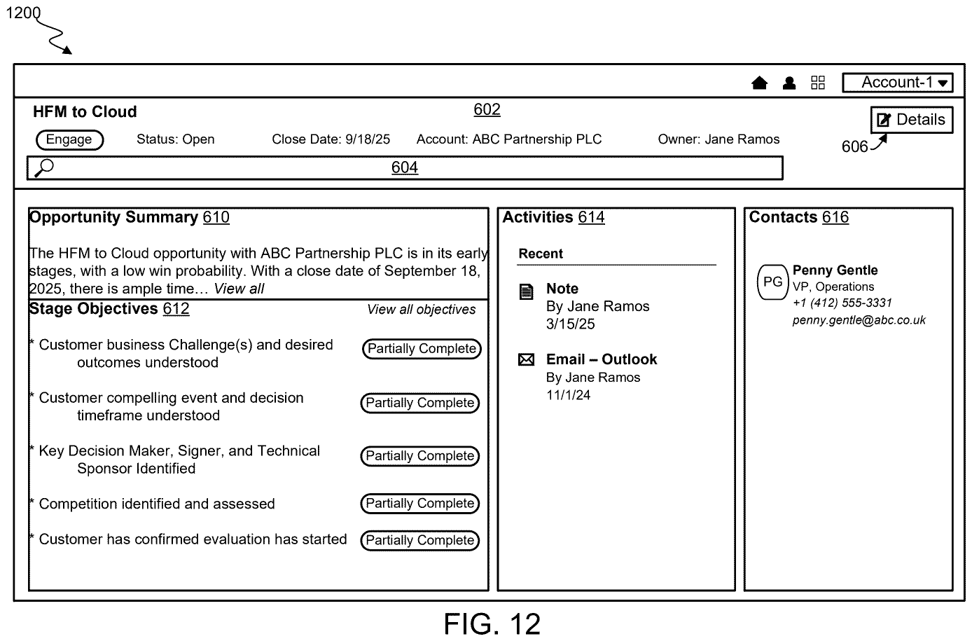

FIG. 12 illustrates a diagram of another example user interface 1200 of the CRM application showing the particular project and including automatic updates generated using one or more AI agents. For instance, the CRM application may update the information in one or more sections of the UI 600 (e.g., summary 610, stage objectives 612, activity 614, etc.) automatically when the user submits new activity data by selecting the update button 1006. For example, as shown in UI 1200, the stage objectives 612 pane was updated automatically (e.g., via the performer agent 212) to remove the last objective (e.g., ‘Funding availability confirmed by Key Decision Maker’) which was displayed in UI 600 before the new data was entered by the user via the input form 1002. As another example, the activities pane 614 was updated to list a new item (e.g., ‘Note’) corresponding to the user input that was received via the input form 1002 of UI 1000 and/or 1100.

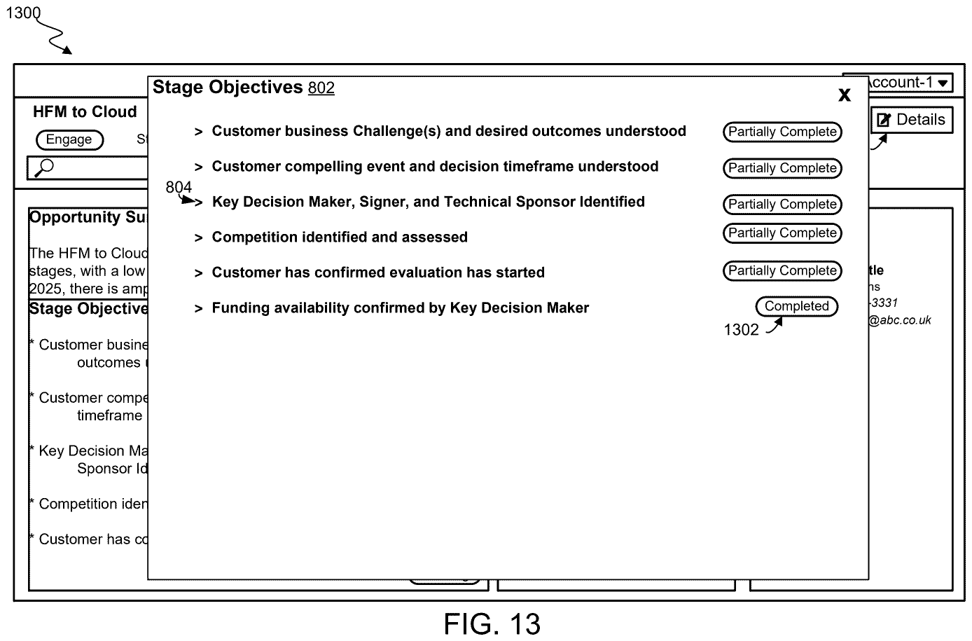

FIG. 13 illustrates a diagram of another example user interface 1200 of the CRM application showing the stage objectives with automatic status updates determined using one or more AI agents. For example, an example system may navigate the user to UI 1200 when the user selects the ‘View all objectives’ link at the top right corner of the state objectives pane 612. As shown, the state objectives GUI element 802 includes the automatically updated details of each objective, such as by marking the status 1302 of the last objective as ‘Completed’ instead of the previous status of ‘Pending’. For example, continuing with the scenario of FIG. 10, this update to the objective status may be incorporated automatically by the system (e.g., via performer agent 212) when the user submits the new user activity data by selecting the update button 1006 in the UI 1000.

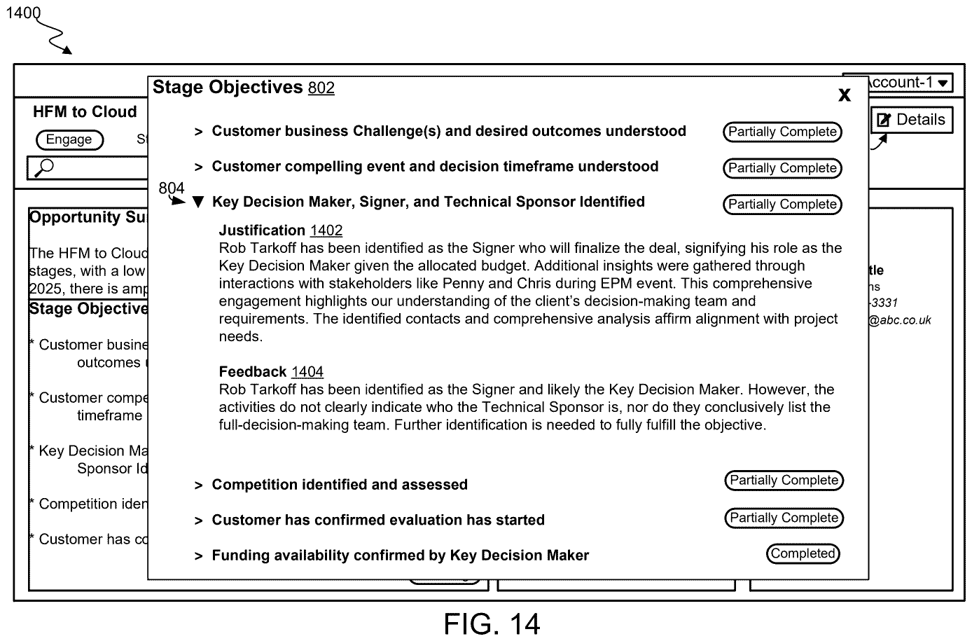

FIG. 14 illustrates a diagram of another example user interface 1400 of the CRM application showing an updated performer recommendation 1402 (e.g., justification 1402) generated automatically by the example performer agent (e.g., performer agent 212) and an updated evaluator recommendation 1404 (e.g., feedback 1404) generated automatically by the example evaluator agent (e.g., evaluator agent 222). For example, the UI 1400 may be similar to the UI 900 except that the justification 1402 and feedback 1404 were updated automatically (e.g., by the performer agent 212) from, respectively, the justification 902 and feedback 904 shown in UI 900 in response to receipt of new activity data via the input form 1002 of the UI 1000. For example, the updated justification 1402 and the updated feedback 1404 account for the new data (e.g., the ‘Note’ item in the activities list 614) analyzed by the performer agent 212 automatically upon receipt.

### Computer System Architecture

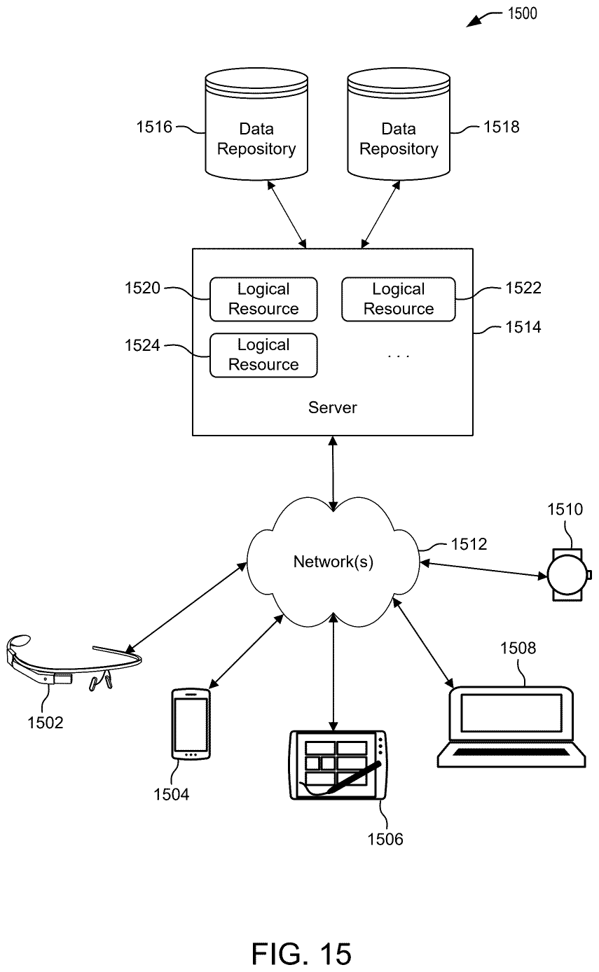

FIG. 15 depicts a simplified diagram of a distributed system 1500 for implementing an embodiment. In the illustrated embodiment, distributed system 1500 includes one or more client computing devices 1502, 1504, 1506, 1508, and/or 1510 coupled to a server 1514 via one or more communication networks 1512. Clients computing devices 1502, 1504, 1506, 1508, and/or 1510 may be configured to execute one or more applications.

In various aspects, server 1514 may be adapted to run one or more services or software applications that enable techniques for using multiple AI agents to simulate performer-evaluator interaction and generate constructive feedback to automate project pipeline progression.

In certain aspects, server 1514 may also provide other services or software applications that can include non-virtual and virtual environments. In some aspects, these services may be offered as web-based or cloud services, such as under a Software as a Service (SaaS) model to the users of client computing devices 1502, 1504, 1506, 1508, and/or 1510. Users operating client computing devices 1502, 1504, 1506, 1508, and/or 1510 may in turn utilize one or more client applications to interact with server 1514 to utilize the services provided by these components.

In the configuration depicted in FIG. 15, server 1514 may include one or more components 1520, 1522 and 1524 that implement the functions performed by server 1514. These components may include software components that may be executed by one or more processors, hardware components, or combinations thereof. It should be appreciated that various different system configurations are possible, which may be different from distributed system 1500. The embodiment shown in FIG. 15 is thus one example of a distributed system for implementing an embodiment system and is not intended to be limiting.

Users may use client computing devices 1502, 1504, 1506, 1508, and/or 1510 for techniques for using multiple AI agents to simulate performer-evaluator interaction and generate constructive feedback to automate project pipeline progression in accordance with the teachings of this disclosure. A client device may provide an interface that enables a user of the client device to interact with the client device. The client device may also output information to the user via this interface. Although FIG. 15 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1514 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1514 can include one or more virtual machines running virtual operating systems, or other computing architectures involving virtualization such as one or more flexible pools of logical storage devices that can be virtualized to maintain virtual storage devices for the server. In various aspects, server 1514 may be adapted to run one or more services or software applications that provide the functionality described in the foregoing disclosure.

The computing systems in server 1514 may run one or more operating systems including any of those discussed above, as well as any commercially available server operating system. Server 1514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1514 may include one or more applications to analyze and consolidate data feeds and/or event updates received from users of client computing devices 1502, 1504, 1506, 1508, and/or 1510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1514 may also include one or more applications to display the data feeds and/or real-time events via one or more display devices of client computing devices 1502, 1504, 1506, 1508, and/or 1510.

Distributed system 1500 may also include one or more data repositories 1516, 1518. These data repositories may be used to store data and other information in certain aspects. For example, one or more of the data repositories 1516, 1518 may be used to store information for techniques for using multiple AI agents to simulate performer-evaluator interaction and generate constructive feedback to automate project pipeline progression. Data repositories 1516, 1518 may reside in a variety of locations. For example, a data repository used by server 1514 may be local to server 1514 or may be remote from server 1514 and in communication with server 1514 via a network-based or dedicated connection. Data repositories 1516, 1518 may be of different types. In certain aspects, a data repository used by server 1514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1516, 1518 may also be used by applications to store application data. The data repositories used by applications may be of different types such as, for example, a key-value store repository, an object store repository, or a general storage repository supported by a file system.

In one embodiment, server 1514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

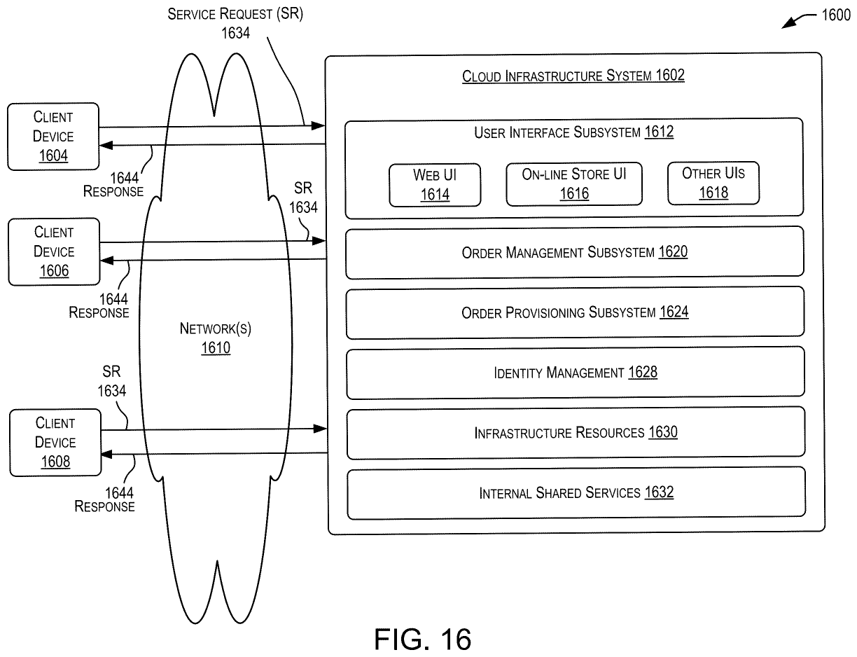

FIG. 16 is a simplified block diagram of a cloud-based system environment in which multiple AI agents are used to simulate performer-evaluator interaction and generate constructive feedback to automate project pipeline progression, in accordance with certain aspects. In the embodiment depicted in FIG. 16, cloud infrastructure system 1602 may provide one or more cloud services that may be requested by users using one or more client computing devices 1604, 1606, and 1608. Cloud infrastructure system 1602 may comprise one or more computers and/or servers that may include those described above for server 1514. The computers in cloud infrastructure system 1602 may be organized as general purpose computers, specialized server computers, server farms, server clusters, or any other appropriate arrangement and/or combination.

Network(s) 1610 may facilitate communication and exchange of data between clients 1604, 1606, and 1608 and cloud infrastructure system 1602. Network(s) 1610 may include one or more networks. The networks may be of the same or different types. Network(s) 1610 may support one or more communication protocols, including wired and/or wireless protocols, for facilitating the communications.

The embodiment depicted in FIG. 16 is only one example of a cloud infrastructure system and is not intended to be limiting. It should be appreciated that, in some other aspects, cloud infrastructure system 1602 may have more or fewer components than those depicted in FIG. 16, may combine two or more components, or may have a different configuration or arrangement of components. For example, although FIG. 16 depicts three client computing devices, any number of client computing devices may be supported in alternative aspects.

The term cloud service is generally used to refer to a service that is made available to users on demand and via a communication network such as the Internet by systems (e.g., cloud infrastructure system 1602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1602. Cloud infrastructure system 1602 then performs processing to provide the services requested in the tenant's subscription order. Cloud infrastructure system 1602 may be configured to provide one or even multiple cloud services.

Cloud infrastructure system 1602 may provide the cloud services via different deployment models. In a public cloud model, cloud infrastructure system 1602 may be owned by a third party cloud services provider and the cloud services are offered to any general public tenant, where the tenant can be an individual or an enterprise. In certain other aspects, under a private cloud model, cloud infrastructure system 1602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1602 and the services provided may be shared by several organizations in a related community. Various other models such as hybrids of the above mentioned models may also be used.

Client computing devices 1604, 1606, and 1608 may be of different types (such as devices 1502, 1504, 1506, and 1508 depicted in FIG. 15) and may be capable of operating one or more client applications. A user may use a client device to interact with cloud infrastructure system 1602, such as to request a service provided by cloud infrastructure system 1602.

In some aspects, the processing performed by cloud infrastructure system 1602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 16, cloud infrastructure system 1602 may include infrastructure resources 1630 that are utilized for facilitating the provision of various cloud services offered by cloud infrastructure system 1602. Infrastructure resources 1630 may include, for example, processing resources, storage or memory resources, networking resources, and the like.

In certain aspects, to facilitate efficient provisioning of these resources for supporting the various cloud services provided by cloud infrastructure system 1602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1602 may itself internally use services 1632 that are shared by different components of cloud infrastructure system 1602 and which facilitate the provisioning of services by cloud infrastructure system 1602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1602 may comprise multiple subsystems. These subsystems may be implemented in software, or hardware, or combinations thereof. As depicted in FIG. 16, the subsystems may include a user interface subsystem 1612 that enables users of cloud infrastructure system 1602 to interact with cloud infrastructure system 1602. User interface subsystem 1612 may include various different interfaces such as a web interface 1614, an online store interface 1616 where cloud services provided by cloud infrastructure system 1602 are advertised and are purchasable by a consumer, and other interfaces 1618. For example, a tenant may, using a client device, request (service request 1634) one or more services provided by cloud infrastructure system 1602 using one or more of interfaces 1614, 1616, and 1618. For example, a tenant may access the online store, browse cloud services offered by cloud infrastructure system 1602, and place a subscription order for one or more services offered by cloud infrastructure system 1602 that the tenant wishes to subscribe to. The service request may include information identifying the tenant and one or more services that the tenant desires to subscribe to. For example, a tenant may place a subscription order for a chatbot related service offered by cloud infrastructure system 1602. As part of the order, the client may provide information identifying the input (e.g. utterances).

In certain aspects, such as the embodiment depicted in FIG. 16, cloud infrastructure system 1602 may comprise a service management subsystem (OMS) 1620 that is configured to process the new order. As part of this processing, OMS 1620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1620 may then invoke the service provisioning subsystem (OPS) 1624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1602 may send a response or notification 1644 to the requesting tenant to indicate when the requested service is now ready for use. In some instances, information (e.g., a link) may be sent to the tenant that enables the tenant to start using and availing the benefits of the requested services.

Cloud infrastructure system 1602 may provide services to multiple tenants. For each tenant, cloud infrastructure system 1602 is responsible for managing information related to one or more subscription orders received from the tenant, maintaining tenant data related to the orders, and providing the requested services to the tenant or clients of the tenant. Cloud infrastructure system 1602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1602 may provide services to multiple tenants in parallel. Cloud infrastructure system 1602 may store information for these tenants, including possibly proprietary information. In certain aspects, cloud infrastructure system 1602 comprises an identity management subsystem (IMS) 1628 that is configured to manage tenant's information and provide the separation of the managed information such that information related to one tenant is not accessible by another tenant. IMS 1628 may be configured to provide various security-related services such as identity services, such as information access management, authentication and authorization services, services for managing tenant identities and roles and related capabilities, and the like.

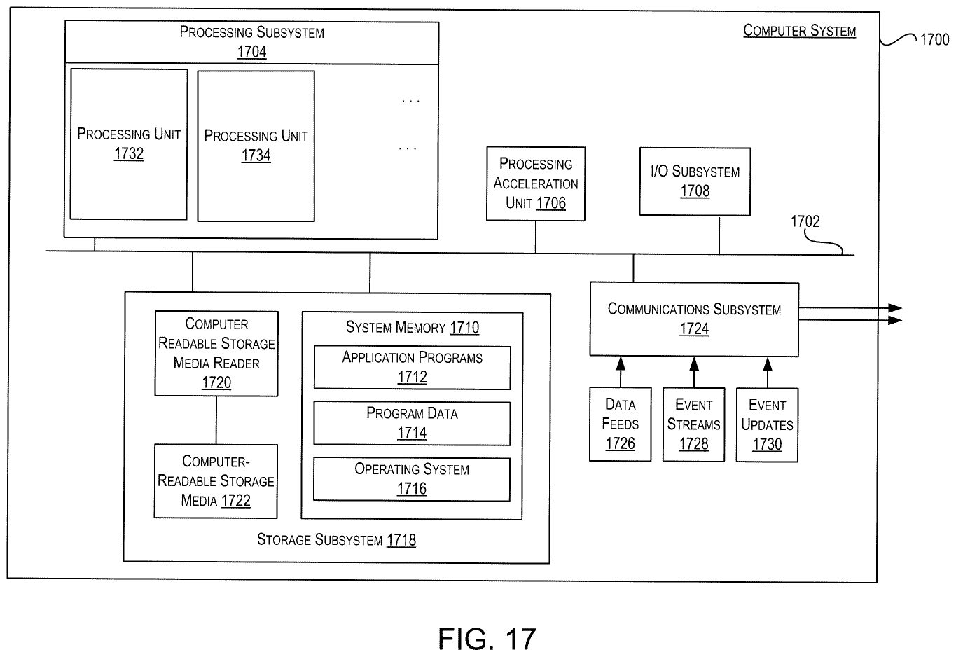

FIG. 17 illustrates an exemplary computer system 1700 that may be used to implement certain aspects. As shown in FIG. 17, computer system 1700 includes various subsystems including a processing subsystem 1704 that communicates with a number of other subsystems via a bus subsystem 1702. These other subsystems may include a processing acceleration unit 1706, an I/O subsystem 1708, a storage subsystem 1718, and a communications subsystem 1724. Storage subsystem 1718 may include non-transitory and/or transitory computer-readable storage media including storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative aspects of the bus subsystem may utilize multiple buses. Bus subsystem 1702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1704 controls the operation of computer system 1700 and may comprise one or more processors, application specific integrated circuits (ASICs), or field programmable gate arrays (FPGAs). The processors may be single core or multicore processors. The processing resources of computer system 1700 can be organized into one or more processing units 1732, 1734, etc. A processing unit may include one or more processors, one or more cores from the same or different processors, a combination of cores and processors, or other combinations of cores and processors. In some aspects, processing subsystem 1704 can include one or more special purpose co-processors such as graphics processors, digital signal processors (DSPs), or the like. In some aspects, some or all of the processing units of processing subsystem 1704 can be implemented using customized circuits, such as application specific integrated circuits (ASICs), or field programmable gate arrays (FPGAs).

In some aspects, the processing units in processing subsystem 1704 can execute instructions stored in system memory 1710 or on computer readable storage media 1722. In various aspects, the processing units can execute a variety of programs or code instructions and can maintain multiple concurrently executing programs or processes. At any given time, some or all of the program code to be executed can be resident in system memory 1710 and/or on computer-readable storage media 1722 including potentially on one or more storage devices. Through suitable programming, processing subsystem 1704 can provide various functionalities described above. In instances where computer system 1700 is executing one or more virtual machines, one or more processing units may be allocated to each virtual machine.

In certain aspects, a processing acceleration unit 1706 may optionally be provided for performing customized processing or for off-loading some of the processing performed by processing subsystem 1704 so as to accelerate the overall processing performed by computer system 1700.

I/O subsystem 1708 may include devices and mechanisms for inputting information to computer system 1700 and/or for outputting information from or via computer system 1700. In general, use of the term input device is intended to include all possible types of devices and mechanisms for inputting information to computer system 1700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1718 provides a repository or data store for storing information and data that is used by computer system 1700. Storage subsystem 1718 provides a tangible non-transitory computer-readable storage medium for storing the basic programming and data constructs that provide the functionality of some aspects. Storage subsystem 1718 may store software (e.g., programs, code modules, instructions) that when executed by processing subsystem 1704 provides the functionality described above. The software may be executed by one or more processing units of processing subsystem 1704. Storage subsystem 1718 may also provide a repository for storing data used in accordance with the teachings of this disclosure.

Storage subsystem 1718 may include one or more non-transitory memory devices, including volatile and non-volatile memory devices. As shown in FIG. 17, storage subsystem 1718 includes a system memory 1710 and a computer-readable storage media 1722. System memory 1710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1700, such as during start-up, may typically be stored in the ROM. The RAM typically contains data and/or program modules that are presently being operated and executed by processing subsystem 1704. In some implementations, system memory 1710 may include multiple different types of memory, such as static random access memory (SRAM), dynamic random access memory (DRAM), and the like.

By way of example, and not limitation, as depicted in FIG. 17, system memory 1710 may load application programs 1712 that are being executed, which may include various applications such as Web browsers, mid-tier applications, relational database management systems (RDBMS), etc., program data 1714, and an operating system 1716. By way of example, operating system 1716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1722 may store programming and data constructs that provide the functionality of some aspects. Computer-readable media 1722 may provide storage of computer-readable instructions, data structures, program modules, and other data for computer system 1700. Software (programs, code modules, instructions) that, when executed by processing subsystem 1704 provides the functionality described above, may be stored in storage subsystem 1718. By way of example, computer-readable storage media 1722 may include non-volatile memory such as a hard disk drive, a magnetic disk drive, an optical disk drive such as a CD ROM, digital video disc (DVD), a Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1718 may also include a computer-readable storage media reader 1720 that can further be connected to computer-readable storage media 1722. Reader 1720 may receive and be configured to read data from a memory device such as a disk, a flash drive, etc.

In certain aspects, computer system 1700 may support virtualization technologies, including but not limited to virtualization of processing and memory resources. For example, computer system 1700 may provide support for executing one or more virtual machines. In certain aspects, computer system 1700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1700. Accordingly, multiple operating systems may potentially be run concurrently by computer system 1700.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to establish a communication channel to one or more client devices via the Internet for receiving and sending information from and to the client devices. For example, the communications subsystem may be used to transmit a response to a user regarding the inquiry for a chatbot.

Communications subsystem 1724 may support both wired and/or wireless communication protocols. For example, in certain aspects, communications subsystem 1724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1724 can provide wired network connectivity (e.g., Ethernet) in addition to or instead of a wireless interface.

Communications subsystem 1724 can receive and transmit data in various forms. For example, in some aspects, in addition to other forms, communications subsystem 1724 may receive input communications in the form of structured and/or unstructured data feeds 1726, event streams 1728, event updates 1730, and the like. For example, communications subsystem 1724 may be configured to receive (or send) data feeds 1726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1724 may be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1724 may also be configured to communicate data from computer system 1700 to other computer systems or networks. The data may be communicated in various different forms such as structured and/or unstructured data feeds 1726, event streams 1728, event updates 1730, and the like to one or more databases that may be in communication with one or more streaming data source computers coupled to computer system 1700.

Computer system 1700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1700 depicted in FIG. 17 is intended only as a specific example. Many other configurations having more or fewer components than the system depicted in FIG. 17 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing, by a performer agent, particular performer-agent-accessible data potentially relevant to a particular project;
generating, by the performer agent, a particular performer recommendation to explain, with reference to at least some of the particular performer-agent-accessible data and from a performer perspective, why the particular project should advance in status according at least to stored objectives; wherein generating the particular performer recommendation comprises generating a particular performer prompt to a large language model that includes a subset of the particular performer-agent-accessible data based at least in part on the particular project;
accessing, by an evaluator agent, particular evaluator-agent-accessible data potentially relevant to the particular project and the particular performer recommendation;
generating, by the evaluator agent, a particular evaluator recommendation to explain, with reference to at least some of the particular performer-agent-accessible data and from an evaluator perspective, why the particular project should not advance in status according at least to the stored objectives; wherein generating the particular evaluator recommendation comprises generating a particular evaluator prompt to a large language model that includes a subset of the particular evaluator-agent-accessible data based at least in part on the particular project;
causing display of at least part of the particular performer recommendation and at least part of the particular evaluator recommendation.

2. The computer-implemented method of claim 1, wherein the particular evaluator prompt includes at least part of the particular performer recommendation.

3. The computer-implemented method of claim 1, further comprising:
configuring the performer agent to consume performer-agent-accessible data potentially relevant to a project and to generate a performer recommendation to explain, with reference to at least some of the performer-agent-accessible data and from the performer perspective, why the project should advance in status according at least to stored objectives; wherein configuring the performer agent to consume the performer-agent-accessible data comprises storing one or more access parameters for the performer agent; wherein configuring the performer agent to generate the performer recommendation comprises configuring the performer agent to generate a prompt to a large language model that includes a subset of the performer-agent-accessible data based at least in part on the project;
configuring an evaluator agent to consume evaluator-agent-accessible data potentially relevant to the project and the performer recommendation and to generate an evaluator recommendation to explain, with reference to at least some of the performer-agent-accessible data and from the evaluator perspective, why the status of the project should not be advanced according at least to the stored objectives; wherein configuring the evaluator agent to consume the evaluator-agent-accessible data comprises storing one or more access parameters for the evaluator agent; wherein the one or more access parameters for the evaluator agent are different than the one or more access parameters for the performer agent; wherein configuring the evaluator agent to generate the evaluator recommendation comprises configuring the evaluator agent to generate a prompt to a large language model that includes a subset of the evaluator-agent-accessible data based at least in part on the project.

4. The computer-implemented method of claim 1, wherein the performer agent accounts for a prior particular evaluator recommendation when generating the particular performer recommendation.

5. The computer-implemented method of claim 4, wherein the evaluator agent accounts for a prior particular performer recommendation when generating the prior particular evaluator recommendation.

6. The computer-implemented method of claim 1, further comprising:
terminating a prior back-and-forth communication session between the performer agent and the evaluator agent based at least in part on determining by the evaluator agent that a prior status is satisfied.

7. The computer-implemented method of claim 1, further comprising:
terminating a prior back-and-forth communication session between the performer agent and the evaluator agent based at least in part on a number of particular evaluator recommendations in the prior back-and-forth communication session satisfying a threshold.

8. The computer-implemented method of claim 1, wherein the particular evaluator-agent-accessible data comprises one or more sets of data that are not included in the particular performer-agent-accessible data.

9. The computer-implemented method of claim 1, wherein the stored objectives include one or more objectives specific to the evaluator agent, and wherein the one or more objectives are specified, via a user interface, by an evaluator user.

10. The computer-implemented method of claim 1, wherein the stored objectives include one or more objectives specific to the performer agent, and wherein the one or more objectives are specified, via a user interface, by a performer user.

11. A computer-program product comprising one or more non-transitory machine-readable storage media, including stored instructions configured to cause a computing system to perform a set of actions including:
accessing, by a performer agent, particular performer-agent-accessible data potentially relevant to a particular project;
generating, by the performer agent, a particular performer recommendation to explain, with reference to at least some of the particular performer-agent-accessible data and from a performer perspective, why the particular project should advance in status according at least to stored objectives; wherein generating the particular performer recommendation comprises generating a particular performer prompt to a large language model that includes a subset of the particular performer-agent-accessible data based at least in part on the particular project;
accessing, by an evaluator agent, particular evaluator-agent-accessible data potentially relevant to the particular project and the particular performer recommendation;
generating, by the evaluator agent, a particular evaluator recommendation to explain, with reference to at least some of the particular performer-agent-accessible data and from an evaluator perspective, why the particular project should not advance in status according at least to stored objectives; wherein generating the particular evaluator recommendation comprises generating a particular evaluator prompt to a large language model that includes a subset of the particular evaluator-agent-accessible data based at least in part on the particular project;
causing display of at least part of the particular performer recommendation and at least part of the particular evaluator recommendation.

12. The computer-program product of claim 11, wherein the particular evaluator prompt includes at least part of the particular performer recommendation.

13. The computer-program product of claim 11, wherein the set of actions further includes:
configuring the performer agent to consume performer-agent-accessible data potentially relevant to a project and to generate a performer recommendation to explain, with reference to at least some of the performer-agent-accessible data and from the performer perspective, why the project should advance in status according at least to stored objectives; wherein configuring the performer agent to consume the performer-agent-accessible data comprises storing one or more access parameters for the performer agent; wherein configuring the performer agent to generate the performer recommendation comprises configuring the performer agent to generate a prompt to a large language model that includes a subset of the performer-agent-accessible data based at least in part on the project;
configuring an evaluator agent to consume evaluator-agent-accessible data potentially relevant to the project and the performer recommendation and to generate an evaluator recommendation to explain, with reference to at least some of the performer-agent-accessible data and from the evaluator perspective, why the status of the project should not be advanced according at least to stored objectives; wherein configuring the evaluator agent to consume the evaluator-agent-accessible data comprises storing one or more access parameters for the evaluator agent; wherein the one or more access parameters for the evaluator agent are different than the one or more access parameters for the performer agent; wherein configuring the evaluator agent to generate the evaluator recommendation comprises configuring the evaluator agent to generate a prompt to a large language model that includes a subset of the evaluator-agent-accessible data based at least in part on the project.

14. The computer-program product of claim 11, wherein the performer agent accounts for a prior particular evaluator recommendation when generating the particular performer recommendation, and wherein the evaluator agent accounts for a prior particular performer recommendation when generating the prior particular evaluator recommendation.

15. The computer-program product of claim 11, wherein the set of actions further includes:
terminating a prior back-and-forth communication session between the performer agent and the evaluator agent based at least in part on determining by the evaluator agent that a prior status is satisfied.

16. A system comprising:
one or more processors;
one or more non-transitory computer-readable media storing instructions, which, when executed by the system, cause the system to perform a set of actions including:
accessing, by a performer agent, particular performer-agent-accessible data potentially relevant to a particular project;
generating, by the performer agent, a particular performer recommendation to explain, with reference to at least some of the particular performer-agent-accessible data and from a performer perspective, why the particular project should advance in status according at least to stored objectives; wherein generating the particular performer recommendation comprises generating a particular performer prompt to a large language model that includes a subset of the particular performer-agent-accessible data based at least in part on the particular project;
accessing, by an evaluator agent, particular evaluator-agent-accessible data potentially relevant to the particular project and the particular performer recommendation;
generating, by the evaluator agent, a particular evaluator recommendation to explain, with reference to at least some of the particular performer-agent-accessible data and from an evaluator perspective, why the particular project should not advance in status according at least to stored objectives; wherein generating the particular evaluator recommendation comprises generating a particular evaluator prompt to a large language model that includes a subset of the particular evaluator-agent-accessible data based at least in part on the particular project;
causing display of at least part of the particular performer recommendation and at least part of the particular evaluator recommendation.

17. The system of claim 16, wherein the set of actions further includes:
terminating a prior back-and-forth communication session between the performer agent and the evaluator agent based at least in part on a number of particular evaluator recommendations in the prior back-and-forth communication session satisfying a threshold.

18. The system of claim 16, wherein the particular evaluator-agent-accessible data comprises one or more sets of data that are not included in the particular performer-agent-accessible data.

19. The system of claim 16, wherein the stored objectives include one or more objectives specific to the evaluator agent, and wherein the one or more objectives are specified, via a user interface, by an evaluator user.

20. The system of claim 16, wherein the stored objectives include one or more objectives specific to the performer agent, and wherein the one or more objectives are specified, via a user interface, by a performer user.
